(19) United States
(12) Patent Application Publication
(10) Pub. No.: US 2025/0207904 A1
(43) Pub. Date: Jun. 26, 2025

(54) SENSING DEVICE AND APPARATUS

(71) Applicant: The University Court of the University of Edinburgh, Edinburgh (GB)

(72) Inventors: Yunjie YANG, Edinburgh (GB); Francesco GIORGIO-SERCHI, Edinburgh (GB); Delin HU, Edinburgh (GB)

(21) Appl. No.: 18/849,317

(22) PCT Filed: Mar. 22, 2023
(86) PCT No.: PCT/GB2023/050720

§ 371 Date: Sep. 20, 2024

(30) Foreign Application Priority Data
Mar. 23, 2022 (GB) 2204054.7

(51) Int. Cl. G01B 7/16; B25J 13/08

(52) U.S. Cl. CPC G01B 7/22; B25J 13/088

(57) ABSTRACT

A sensing device comprising: a plurality of electrodes configured to be distributed about one or more surfaces of a deformable object, wherein the plurality of electrodes are operable to generate capacitance signal output from a plurality of selected pairings of the plurality of electrodes, wherein the plurality of electrodes are distributed about the one or more surfaces of a deformable object such that the plurality of selected pairings comprise at least one proximate pairing and at least one non-proximate pairing, wherein the generated capacitance signal output for a pairing of electrodes is dependent on at least one of: a distance between the electrodes; shape and/or orientation of the electrodes and at least one property of the material between the pairing.

### FIELD

The present invention relates to a sensing device and apparatus, for example, a sensing device and apparatus for use with a deformable object.

### BACKGROUND

Humans can effortlessly perceive their posture, movement, and position via mechano-sensory neural networks distributed throughout their bodies. This ability, known as proprioception, enables humans to efficiently and accurately control their bodies, and is also an essential requirement for intelligent robots to undertake dexterous operations. Proprioception systems for rigid robots are known and applied in a number of applications.

### SUMMARY

In accordance with a first aspect there is provided a sensing device comprising: a plurality of electrodes configured to be distributed about one or more surfaces of a deformable object, wherein the plurality of electrodes are operable to generate signal output from a plurality of selected pairings of the plurality of electrodes. The plurality of electrodes may be distributed about the one or more surfaces of a deformable object such that the plurality of selected pairings comprise at least one proximate pairing and at least one non-proximate pairing. The generated signal output for a pairing of electrodes may be dependent on at least one of: a distance between the electrodes; shape and/or orientation of the electrodes and at least one property of the material between the pairing. The generated signal output may comprise capacitance signal output.

The sensing device may be for use with a deformable object. The sensing device may be integrated into the deformable object. The plurality of electrodes may be integrated into the deformable object and/or disposed onto the surface or exterior of the deformable object. The plurality of electrodes may form part of a conformable layer or skin. The conformable layer or skin may be conformable to at least part of the surface of the deformable object. The at least one property may comprise permittivity and/or conductivity of material.

The generated capacitance signal output may be processable to determine information associated with the deformable object, wherein the information comprises at least one of: shape information; deformation information; force information; and/or velocity field information.

At least one of the plurality of electrodes may be deformable, stretchable and/or compressible.

The plurality of electrodes may comprise two or more proximal electrodes and two or more distal electrodes. The selected pairings may comprise at least one pairing between a proximal electrode and a distal electrode and at least one pairing between two proximal electrodes and/or at least one pairing between two distal electrodes.

The plurality of selected pairings may comprise at least one pairing between two electrodes provided distally from each other and at least one pairing between two electrodes provided proximally to each other.

The at least one pairing between distal electrodes and the at least one paring between proximal electrodes may provide global shape and/or deformation information and local shape and/or deformation information.

The plurality of electrodes may be distributed in one or more layers and the at least one pairing may comprise pairings between electrodes in the same or adjacent layers.

At least two of the selected plurality of pairings may comprise a common electrode.

The capacitance signal output may comprise capacitance values for each selected pairing of the plurality of pairings. The capacitance values may be in dependence on at least one of: a spatial relationship between the pairing; a distance between the pairing; surface area of each electrode of the pairing; a relative orientation of the pairing; at least one material property, for example, permittivity, of the material between the pairing.

The plurality of electrodes may be distributed along the one or more surfaces thereby to form a three dimensional spatial distribution wherein the three dimensional spatial configuration is continuously deformable from a planar configuration.

The plurality of electrodes may be distributed along and/or across one or more surfaces of the deformable object. The plurality of electrodes may be distributed laterally about one or more surfaces of the deformable object. The plurality of electrodes may define a sensing volume corresponding to a shape of at least part of the object.

The capacitance signal output may be processable to obtain deformation information associated with at least one of: bending, twisting, elongation, expansion, compression of the object.

The plurality of electrodes may be laterally disposed along a first surface of the deformable object and at least a second surface of the deformable object.

The electrodes may define a sensing volume having a shape that corresponds to at least part of the shape of the deformable object. The plurality of electrodes may be distributed about an exterior of the deformable object.

The electrodes may be distributed to cover at least of the exterior of the deformable object. The electrodes may cover at least 50%, optionally 75%, optionally 90% The electrodes may span substantially all of the exterior of the deformable object.

The plurality of selected pairings may comprise at least one pairing of a first electrode with a non-neighbouring electrode of the plurality of electrodes.

The plurality of electrodes may be operable to generate capacitance signal output from the plurality of selected pairings in accordance with a pre-determined sequence.

The plurality of selected parings may comprise a subset, for example, a degenerate subset, of all pairings of the plurality of electrodes.

The plurality of electrodes may comprise at least two electrodes arranged in a first plane and at least two electrodes arranged is in a second plane, wherein the first plane is substantially non-parallel to the second plane.

The plurality of electrodes may be disposed in or on one or more deformable substrates, the one or more deformable substrates being conformable to a surface by deformation.

The one or more deformable substrates may be stretchable. The one or more deformable substrates may be stretchable in at least a lateral direction.

The one or more deformable substrates may be stretchable to increase or decrease a distance between two or more of the plurality of electrodes.

The plurality of electrodes may form one or more sensor modules, wherein each sensor module is continuously deformable from a planar configuration and/or conformable to a surface. In the planar configuration, the plurality of electrodes may be arranged in one or more layers and/or rows and/or columns. In the planar configuration, the plurality of electrodes may be arranged in a grid-like distribution.

The plurality of electrodes may comprise a stretchable conductive material. The sensing device may comprise deformable connections between the plurality of electrodes. The deformable connections may comprise a stretchable conductive material.

The stretchable conductive material may comprise at least one of: carbon black elastomer conductive hydrogel and/or liquid metal.

The plurality of electrodes may comprise an elongated conductive portion, wherein the elongated conductive portion is configured to be further elongated in response to a force, The elongated conductive portions of the plurality of electrodes may be provided in a parallel arrangement.

The plurality of electrodes may be provided on or integrated into one or more deformable substrates for applying to the deformable object.

The one or more electrodes may be integrated into the surface of the deformable object.

The deformable object may comprise at least one of: a robot arm; other robotic manipulator; a part of a human body and/or a wearable object.

The plurality of electrodes may be distributed in accordance with a pre-determined layout. The pre-determined layout may be determined using a machine learning derived process.

The sensing device may further comprise a processing resource configured to process capacitance signal output or capacitance data obtained from the capacitance signal output to obtain said information associated with the deformable object.

The processing circuitry may be configured to apply at least one pre-determined model to obtain said information. The at least one pre-determined model may comprise a model trained used a machine-learning derived process.

Obtaining shape information may comprise at least one of: obtaining reconstructed shape data; obtaining a graphical representation of at least part of the deformable object; determining one or more dimensions or other physical parameter of the deformable object; performing a shape reconstruction process. The reconstructed shape data may comprise full-geometry high-resolution 3D shape data.

Obtaining deformation information may comprise determining at least one of: a magnitude of deformation applied to the deformable object; a type of deformation applied to the deformable object.

Obtaining force information may comprise determining at least one of a magnitude and/or force exerted on at least part of the deformable object. Obtaining force information may comprise determining a force on the deformable object from a further object. Obtaining force information may comprise determining touch information dependent on at least a change in permittivity.

Obtaining velocity field information may comprise determining at least one of: a velocity field map for the deformable object.

The sensing device may be configured to perform at least one of: a shape reconstruction process and/or a deformation sensing process and/or a force sensing process and/or a deformation classification process and/or a velocity field map generation process.

The sensing device may comprise an electrode driving module configured to selectively drive one or more of the plurality of electrodes to generate the capacitance signal output from the selected plurality of pairings. The sensing device may comprise a capacitance signal readout module configured to read the generated capacitance signal output and generate capacitance signal data.

One or more of the selected pairings may comprise two or more electrodes, optionally three or more electrodes. The plurality of selected pairings may comprise a pairing between a first group of one or more electrodes and a second group of one or more electrodes. The first group of electrodes may be operable to form a first combined electrode and the second group of one or more electrodes may be operable to form a second combined electrode. The first and second combined electrodes may be operable to produce capacitance signal output.

In accordance with a second aspect, there is provided a sensing apparatus comprising the sensing device of the first aspect. The sensing apparatus may further comprise a display for displaying a visual representation of the shape of the deformable object.

The sensing apparatus may further comprise at least one of: a processing resource configured to process capacitance signal output or capacitance data obtained from the capacitance signal output to obtain said information associated with the deformable object; an electrode driving module configured to selectively drive one or more of the plurality of electrodes to generate the capacitance signal output from the selected plurality of pairings. The sensing device may comprise a capacitance signal readout module configured to read the generated capacitance signal output and generate capacitance signal data.

The sensing apparatus may comprise signal routing circuitry operable to connect each of the plurality of electrodes to at least one of the driving circuit and the signal readout circuitry. The signal routing circuitry may be controllable using one or more control signals.

In accordance with a third aspect, that may be provided independently, there is provided a method comprising: obtaining signal output data representative of signal output from a plurality of selected pairings of a plurality of electrodes distributed about one or more surfaces of a deformable object, wherein the generated signal output for a pairing of electrodes is dependent on at least one of: a distance between the pairing; shape and/or orientation of the electrodes and at least one material property of the material between the pairing; and processing the signal output data to determine information associated with the deformable object. The signal output may comprise capacitance signal output and the signal output data may comprise capacitance signal output data.

The processing of the capacitance signal output data may comprise using at least one pre-determined model. The at least one model may be pre-determined using a machine learning derived process. The at least one pre-determined model may relate capacitance signal for the plurality of electrodes to said information.

The processing of the capacitance signal output may be performed as part of at least one of: a shape reconstruction process, a deformation detection process. The processing of the capacitance signal output may be performed as part of a touch detection process. The processing of the capacitance signal output may be performed as part of a simultaneous touch detection and deformation detection process.

The at least one model may be configured to output touch information and deformation information. The at least one model may comprise at least two models comprising: a first model for outputting touch information and a second model for outputting deformation information. Touch information may comprises touch location information. Touch information may comprise contact location information.

In accordance with a fourth aspect, which may be provided independently, there is provided a method for training at least one model comprising: obtaining training data comprising: signal output data representative of signal output from a plurality of selected pairings of a plurality of electrodes distributed about one or more surfaces of a deformable object; and further data representative of information for the plurality of electrodes; performing a model training process using the obtained training data to obtain at least one trained model for obtaining further information of interest for the plurality of electrodes using further obtained signal output. The signal output may comprise capacitance signal output and the signal output data may be representative of capacitance signal output. The further signal output may comprise further capacitance signal output.

The obtained capacitance signal output data may be obtained for one or more spatial configurations of the plurality of electrodes and/or in response to one or more deformations applied to the deformable object. The obtained information may comprise shape and/or deformation information data corresponding to the one or more spatial configuration and/or the one or more applied deformations.

Obtaining the shape and/or deformation information data may comprise performing a sensing process on the deformable object when the deformable object is in each of the one more spatial configurations and/or in response to the one or more deformations.

Obtaining the shape and/or deformation information data may comprise obtaining image and/or depth sensor data of the deformable object when in the plurality of spatial configuration and/or in response to the one or more deformations and processing the image and/or depth sensor data.

The image and/or depth sensor data may comprise 3D shape representation data, for example, point cloud data, and/or data representative of further derived parameters.

The obtained capacitance signal output data may be obtained in response to performing a sequence of contact actions at a plurality of locations on the one or more surfaces. The obtained information may comprise contact location information.

In accordance with a fifth aspect, which may be provided independently, there is provided an apparatus comprising a processing resource configured to: obtain signal output data representative of signal output from a plurality of selected pairings of a plurality of electrodes distributed about one or more surfaces of a deformable object, wherein the generated signal output for a pairing of electrodes is dependent on at least one of: a distance between the pairing; shape and/or orientation of the electrodes and at least one material property of the material between the pairing; and process the signal output data to determine information associated with the deformable object. The signal output may comprise capacitance signal output and the signal output data may comprise capacitance signal output data.

In accordance with a sixth aspect, which may be provided independently, there is provided an apparatus comprising a processing resource configured to: obtain training data comprising: signal output data representative of signal output from a plurality of selected pairings of a plurality of electrodes distributed about one or more surfaces of a deformable object; and further data representative of information for the plurality of electrodes; perform a model training process using the obtained training data to obtain at least one trained model for obtaining further information of interest for the plurality of electrodes using further obtained signal output. The signal output may comprise capacitance signal output and the signal output data may be representative of capacitance signal output. The further signal output may comprise further capacitance signal output.

In accordance with a seventh aspect there is provided a non-transitory computer readable medium comprising instructions operable by a processor to perform the method of the third aspect or the fourth aspect.

Features in one aspect may be provided as features in any other aspect as appropriate. For example, features of the device or apparatus may be provided as features of a method and vice versa. Any feature or features in one aspect may be provided in combination with any suitable feature or features in any other aspect.

### BRIEF DESCRIPTION OF THE FIGURES

Various aspects of the invention will now be described by way of example only, and with reference to the accompanying drawings, of which:

FIG. 1 is a schematic diagram of a sensor apparatus, in accordance with embodiments;

FIG. 2 shows a sensing device in an unassembled and assembled configuration;

FIG. 3 illustrates sensing capacitance between proximate and non-proximate pairings of electrodes;

FIG. 4(a) is a top-down view of a sensor module, FIG. 4(b) is a first cross-sectional view of the sensor module and FIG. 4(c) is an exploded, cross-sectional view of the sensor module;

FIG. 5 depicts types of deformation applied to the sensing device;

FIG. 6 is a flowchart showing, in overview, a method of obtaining deformation information using a trained model;

FIG. 7 is a flowchart showing, in overview, a method of training a model for obtaining deformation information;

FIG. 8 is a schematic diagram of a model architecture, in accordance with an embodiment;

FIGS. 9(a) and 9(b) show the output of a trained model, in accordance with embodiments;

FIG. 10 shows a number of electrode arrangements, in accordance with further embodiments;

FIG. 11 depicts results from a neural network trained to classify type of deformation applied to an object using signal output, in accordance with an embodiment;

FIG. 12 depicts results from a neural network trained to determine a magnitude and direction of force applied to an object using signal output, in accordance with an embodiment;

FIG. 13 depicts a sensing device in an unassembled and assembled configuration, in accordance with a further embodiment;

FIG. 14 depicts a sensing device in accordance with a further embodiment;

FIG. 15(a) is a top-down view of a sensor module in accordance with a further embodiment, FIG. 15(b) is a second top-down view of the sensor module and FIG. 15(c) is an exploded, cross-sectional view of the sensor module;

FIG. 16 is a view of a manipulator;

FIG. 17 depicts results obtained using the sensor module of FIG. 15;

FIG. 18 depicts further results obtained using the sensor module of FIG. 15;

FIG. 19 depicts touch regions using the sensor module of FIG. 15;

FIG. 20 is a schematic diagram of a model architecture, in accordance with an embodiment;

FIG. 21 depicts a confusion matrix obtained during training of a neural network model; and

FIG. 22 depicts further experimental results obtained using the sensor module of FIG. 15.

### DETAILED DESCRIPTION

The following embodiments relate to a sensing apparatus for use with a deformable object, as a non-limiting example, a robot arm or robot manipulator. The sensing apparatus is configured to obtain capacitance signal output that can be processed to obtain information about or associated with the deformable object. In the following, the embodiments described obtaining, for example, shape and/or deformation information. However, it will be understood that other information may be derived from the capacitance signal output (for example, force information, velocity field information).

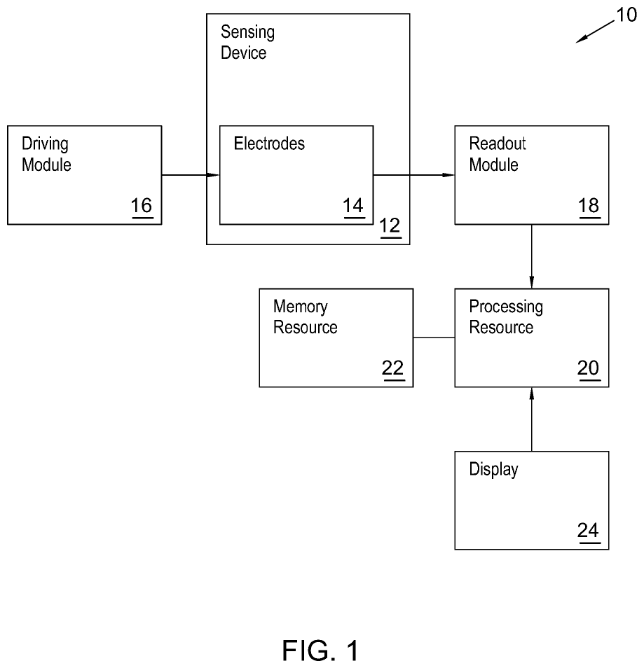

FIG. 1 is a schematic diagram of a sensing apparatus 10, in accordance with embodiments. The sensing apparatus 10 has a sensing device 12 comprising a plurality of electrodes 14, referred to as electrodes 14, for brevity. The sensing apparatus 10 also has a driving module 16, a readout module 18, a processing resource 20, a memory resource 22 and a display 24. The electrodes 14 are configured to be distributed along one or more surfaces of a deformable object (not shown in FIG. 1). The readout module may also be referred to as readout electronics and/or readout circuitry. Likewise, the driving module may also be referred to as driving electronics and/or driving circuitry.

The plurality of electrodes 14 are distributed about an exterior surface of a deformable object, for example, part of a soft-robot such as a robot arm or robot manipulator. The electrodes may be distributed along, for example, laterally along and/or across one or more surfaces of the deformable object. The plurality of electrodes can be considered to define a sensing volume that covers at least part of the shape of the object, in some embodiment, substantially all of the object. While the example of a robot arm and robot manipulator are described in the following, it will be understood that the apparatus can be used in a number of different applications and at a number of different scales.

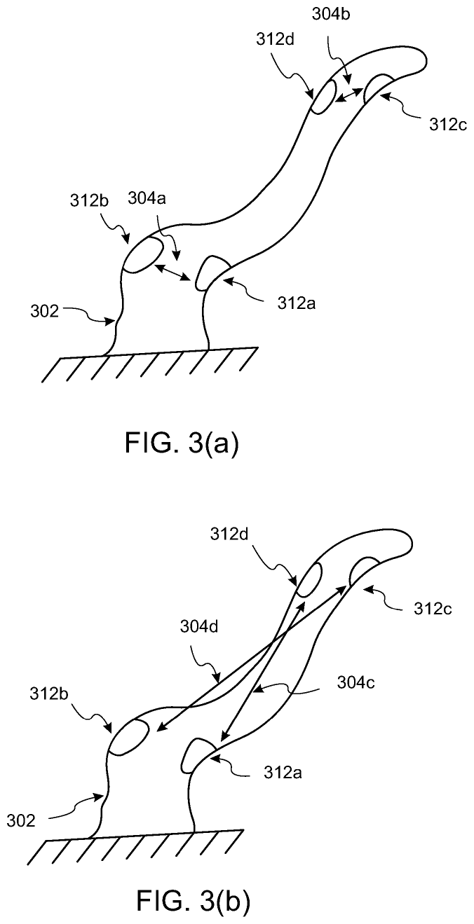

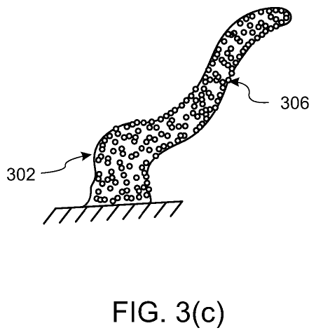

The plurality of electrodes 14 have a distribution such that each electrode can form proximate and non-proximate (also referred to as remote) pairings with other electrodes of the plurality of electrodes. The electrodes in such a distribution are thus operable to obtain capacitance readings from both proximate and remote pairings. Proximate and remote pairings are described in further detail with reference to FIG. 3.

In general, any pairing of the plurality of electrodes can generate a capacitance output. For a capacitance formed between different pairs of electrodes, the capacitance is sensitive to properties of the region between the electrodes.

The capacitance value for a pairing of electrodes can be approximately represented mathematically by the following mathematical relation:

$$C \approx \frac{ε S}{4 π kd}$$

The capacitance value (C) between a pair of electrodes is therefore dependent on properties of the material between the two electrodes (in this case, permittivity ε), the distance between the two electrodes (d) and the surface area of the electrode S. The surface area of the electrodes visible to will change depending on the relative orientation of the electrodes. S in the above equation is a measure of the overlapping area of the two electrodes. Further, it will be understood that the above equation is an approximation.

In response to deformation or a change in, for example, environmental conditions, the shape of the electrode may change (corresponding to the area S), the distance may also change and the permittivity (or other relevant material property, for example, conductivity) may change. The measured capacitance value will therefore change in value response to any such changes.

The sensing strategy described in the following includes collecting a number of capacitance values from a number of selected pairings of the electrodes. The specific number and selection of capacitance values collected may be referred to as the sensing strategy. The capacitance signal output can be processed to obtain information for the deformation object (for example, deformation information or shape information) to be obtained. In some embodiments, the obtained information is deformation information collected across the 3D domain of the object enabling a shape reconstruction process for the object to be performed. In other embodiment, the obtained information is force or velocity field information. As the capacitance signal output includes information relating to the above measurements (e.g. shape, distance, material properties), in principle, the capacitance signal output can be processed to obtain a quantity derivable from these measurements.

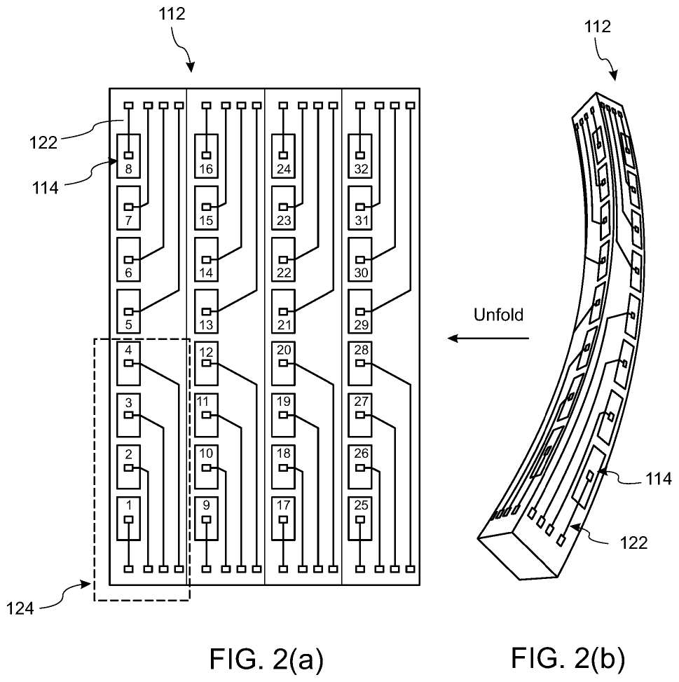

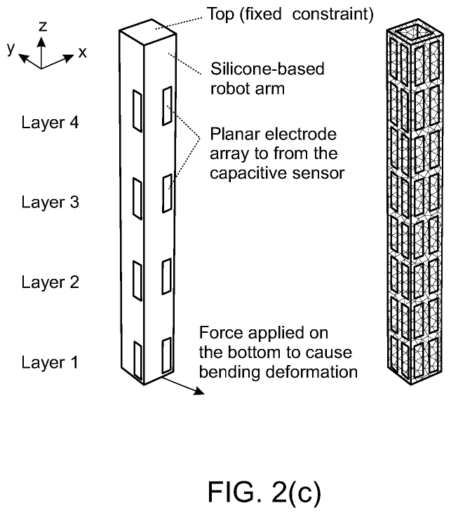

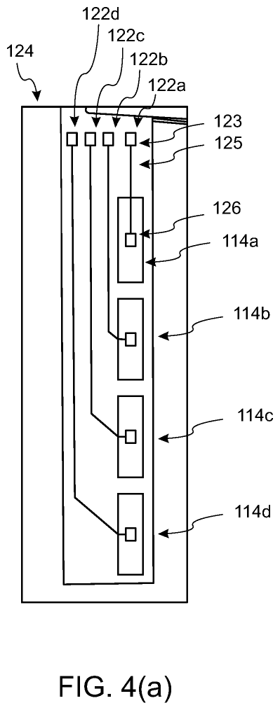

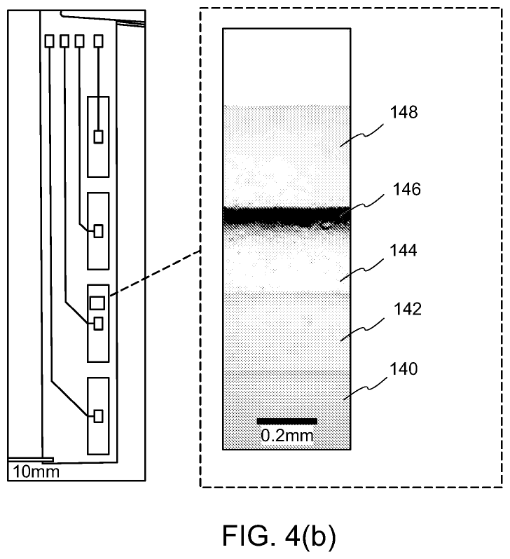

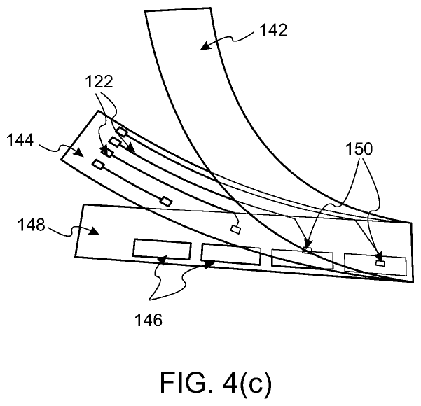

The sensing apparatus 10 has electronic connections between the sensor device 12 and the driving/readout module configured to communicate driving signals from the driving module 16 to the electrode 14 and capacitance signals form the electrodes 14 to the readout module 18. In accordance with embodiments, each electrode has a corresponding electronic connection to allow individual electrodes to be addressed. Part of this electronic connection is provided as a conductive link in the sensing device itself, as described with reference to FIGS. 2 and 4.

The processing resource is configured to combine capacitance signal output from both proximate and non-proximate pairings of the plurality of electrodes and process said output signals to obtain shape and/or deformation information. The processing resource may perform a shape reconstruction or deformation detection process using the capacitance signal output. In other embodiments, the processing resource may derive one or more further properties dependent on at least one of shape, distance and material properties.

In such a shape reconstruction or deformation detection process, the obtained shape information may be, for example, a graphical representation of a reconstructed 3D shape of at least part of the deformable object. The shape information may be a dimension of the deformable object. The obtained deformation information may be, for example, a magnitude of a type of force or a type of deformation applied to the object.

The processing resource 20 may be any suitable processing circuitry. In some embodiments, the processing resource 20 is, for example, an FPGA or ASIC hardware. The processing resource may be an edge-based processing resource, for example, NVIDIA Jetson Nano.

In use, the driving module 16 drives the plurality of electrodes in accordance with a sensing strategy to obtain capacitance signals from selected pairings of the electrodes. The sensing strategy may target a subset of electrodes. In some embodiments, a degenerate subset is targeted in which, for example, capacitance readings from repeated or degenerate pairings are not read. In response to the driving signals, the plurality of electrodes 14 then generate capacitance signal output between selected pairings, including both proximate and remote pairings. The capacitance signal output is then processed, by processing resource 20, to obtain, for example, shape information or deformation information for the deformable object. As described in the following, the processing of the capacitance signal output may include using a trained model for transforming capacitance signal output data into the desired information (e.g. shape or deformation information).

FIG. 2 depicts a sensing device 112, in accordance with an embodiment. It will be understood that sensing device 112 corresponds to sensing device 12 and is operable as part of a sensing apparatus as described with reference to FIG. 1.

FIG. 2(a) depicts the sensing device 112 in a dis-assembled configuration. In this embodiment, the dis-assembled configuration is an unfolded configuration such that the electrodes 114 are in a planar grid. In this embodiment, the grid corresponds to an 8×4 array of electrodes. As depicted in FIG. 2(a), each electrode 114 has a corresponding conductive link 122. In this embodiment, the sensing device 112 is composed of 8 sensor modules, where each sensing module is a four electrode sensor module. For illustrative purposes, a sensor module 124 is indicated in FIG. 2(a). Further description of individual sensor module 124 is provided with reference to FIG. 4.

As depicted in FIG. 2(a), each electrode is numbered. It will be understood that each electrode has an address (or array number). As each electrode has a respective conductive link, the driving module can address one or more particular electrodes at a given time or in accordance with a sequence or pattern and the readout module can also attribute a readout from a particular electrode.

In the present embodiment, the driving sequence includes proximate and non-proximate electrode pairs to ensure the diversity of the readouts and enlarge the sensing field. In some embodiments, the capacitance value may be small if the two electrodes are too far apart. In such cases, the driving sequence may only use readings from electrode pairs in the same layer and across adjacent layers.

FIG. 2(b) depicts the sensing device 112 in an assembled configuration, in which the substrate of the sensing device is folded and conformed to a surface of a deformable object. In the present embodiment, the deformable object is a robotic arm. In the assembled configuration, the plurality of electrodes are distributed laterally along four surfaces of the deformable object. The sensing device 112, in the conformed configuration has a first, second, third and fourth set of electrodes distributed laterally along a first, second, third and fourth surface, respectively. When assembled and conformed to the deformable object, the electrodes can be considered to form a sensing volume that has a shape corresponding to the shape of the deformable object.

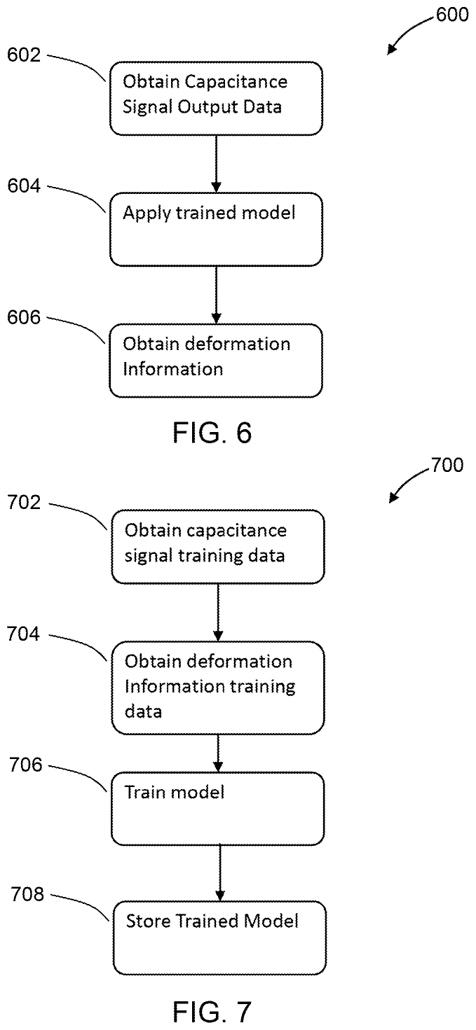

In the present embodiment, the 32-electrode sensing device 122 is deployed on a mock-up robot arm, consists of eight 4-electrode modules. The capacitance values are read out by an electrical circuit (the readout module) at approximately 30 fps (however, other sample rates may be used). As described with reference to FIGS. 6 and 7, neural network based methods may be employed to recover 3D deformations from the capacitance signal readouts.

While FIG. 2 depicts a sensing device that is foldable, it will be understood that this is provided as a non-limiting example only and that the plurality of electrodes may be distributed along one or more surfaces of objects having different shapes. As a non-limiting example, the shape may include, gloves, a snake-shape or other irregular shapes.

The embodiment of FIG. 2 illustrates that the sensing device may be modular in some embodiments and composed of one or more deformable sensor modules that can be secured to surfaces of an object. The sensor modules may be considered to form part or patches of a stretchable skin for an object. However, it will also be understood that in further embodiments, the electrodes are themselves integrated into part of the object or disposed onto an outer layer of the object. In further embodiments, some electrodes may be integrated in the object itself and other electrodes may be provided as a module or separate layer that is applied and secured to the object.

FIG. 2 can be considered to depict 8 layers of electrodes across different modules (for example, electrodes 1, 9, 17 and 25 are considered to be in the same layer). The layer here may also be referred to as a row. In some embodiments, the apparatus is configured to obtain capacitance values from electrodes in the same layer (for example, between electrode 12 and 20) or from electrodes in adjacent layers (for example, electrode 4 and 5).

FIG. 2(c) depicts the layers of the robot arm in further detail. A 16 electrode capacitive sensor is depicted on the left hand side. FIG. 2(c) depicts four layers: layer 1, layer 2, layer 3 and layer 4. Each layer has four electrodes that together provide up to 6 capacitance readouts. A mesh representation of the robot arm is provided on the right hand side. In this embodiment, the top (above layer 4) of the robot arm is fixed. The rest of the robot arm is free to move in response to an applied force (that will cause deformation).

As described above, the plurality of electrodes are operable to generate capacitance signals between selected pairings of the electrodes. FIG. 3 illustrates a deformable object 302, in this example, a soft robot arm. In the illustration of FIG. 3, four electrodes are depicted: first electrode 312a, second electrode 312b, third electrode 312c and fourth electrode 312d. The object 302 extends outwards from a surface and has a proximal portion and a distal portion. The first and second electrodes (312a, 312b) are provided at surfaces in the proximal portion and may be referred to as proximal electrodes. The third and fourth electrodes (312c, 312d) are provided at surfaces at the distal portion and may be referred to as distal electrodes.

In FIG. 3(a), two pairings are indicated: a first pairing 304a (between first electrode 312a and second electrode 312b) and a second pairing 304b (between third electrode 312c and fourth electrode 312d). The first pairing 304a may be considered as a pairing between two proximal electrodes and the second pairing 304b may be considered as a pairing between two distal electrodes. In FIG. 3(b), two further pairings between the electrodes are indicated: a third pairing 304c (between first electrode 312a and fourth electrode 312d) and a fourth pairing 304d (between second electrode 312b and third electrode 312c). Both the third pairing 304c and the fourth pairing 304d may be considered as a pairing between a proximal electrode and a distal electrode.

Whether an electrode pair is considered proximal or distal may depend on, for example, the distance between two electrodes. In some embodiments, the capacitance between two electrodes may not be measured if there are other electrodes between them. However, if the electrodes are in adjacent layers, for example, they are in the same or adjacent layers, for example, like the electrodes 1-2 in FIG. 2, then a capacitance value may be returned. In some embodiments, proximal pairings may be considered as two electrodes that are adjacent. Distal pairings may be considers as two electrodes that are not adjacent and, for example, they have an electrode between them. In some embodiments, only the capacitance formed by adjacent electrodes are measured.

The above embodiments, provide examples of subsets of all possible pairings that can be used. It will be understood that in some embodiments, capacitance output from subsets of all possible pairings is used. Such output may include, for example, degenerate subset pairings that only include degenerate or non-repeating pairings.

As shown in FIGS. 3(a) and 3(b) at least two of the pairings have a common electrode. For example, first pairing 304a and third pairing 304c have a common electrode (first electrode 312a). Likewise, for example, first pairing 304a and fourth pairing 304d have a common electrode (second electrode 312b).

It will be understood that the term proximal and distal used here refer to placement relative to the proximal and distal portions of the robot arm, which is extending outwards from a surface. However, for this object and for other shapes of objects, the selected pairings of electrodes referred to in terms of their proximity or closeness to each other. Therefore, the first pairing 304a may be referred to as a proximate pairing and, likewise, the second pairing 304b may be referred to as proximate pairing. The third pairing 304c may be referred to as a non-proximate pairing and, likewise, the fourth pairing 304d may be referred to a non-proximate pairing. Non-proximate pairings may also be referred to as remote pairings.

A proximate pairing for an electrode may include any electrode that falls within a pre-determined region (for example, an area or volume) about an electrode. The pre-determined region may define a neighbourhood such that any electrode within the neighbourhood is referred to as a neighbouring electrode and any electrode outside the neighbourhood is referred to as a non-neighbouring electrode. In such a description, proximate pairings may correspond to the set of neighbouring electrodes. Proximate pairing for an electrode may include, but not be limited to the nearest neighbours of electrodes.

As described above, the magnitude of a measured capacitance between a pair of electrodes is dependent on at least the distance between the two electrodes. Therefore, it operation, stronger capacitance signals are sensed for first pairing 304a and second pairing 304b due to their proximity to each other in comparison to the weaker capacitance signals sensed for third pairing 304c and fourth pairing 304d. In general, proximate pairings will measure larger values of capacitance than remote pairings.

For the purposes of shape reconstruction and deformation sensing, it has been found that if using only strong signals between neighbouring electrodes, then a reliable shape may not be reconstructed. Likewise, if only weak signals between remote pairings, a reliable shape is not reconstructed. As depicted in FIG. 3(c) by combining capacitance signal output from both proximate and remote pairings of electrodes, the model can reconstruct an accurate geometry and shape. FIG. 3(c) illustrates a plurality of points 306 that together provide a reconstructed point cloud for the robotic soft arm 302. Therefore, it has been found that by receiving capacitance signal output from proximate and non-proximate pairings of electrodes and processing said output, local and global shape and/or deformation information may be obtained. The point cloud used here is one example representation of the shape information for the object. It will be understood that the point cloud is independent of the number of electrodes.

The distribution of electrodes may define a sensing volume that covers a certain fraction of the volume of the object. Likewise, the distribution of electrodes may define a sensing are area that spans a certain fraction of an exterior surface area of the object. For example, the fraction may be part of the exterior of the deformable object. As a non-limiting example, the fraction may be at least 50%, optionally 75%, optionally 90% of the exterior of the deformable object. In some embodiments, the electrodes may span substantially all of the exterior of the deformable object. The distribution of the electrodes may be regularly spaced or unevenly spaced (such that density of electrodes varies over the surface). The density of the distributed electrodes will depend on the object being measured.

FIG. 4(a) is a top-down view of four electrode sensor module 124 used to form sensing device 112. The four electrode sensor module has a first electrode 114a, a second electrode 114b, a third electrode 114c and a fourth electrode 114d. The sensor module is fabricated to be deformable under force, for example, stretchable, twistable and/or compressible.

Each electrode has a corresponding conductive link for linking the electrode to further electronics, for example, readout module and driving module. The conductive link for an electrode may be referred to an electrode link or simply as a link. The link provides a conductive path between the electrode at a first part of the sensor module and a connector at a further part of the sensor module. FIG. 4(a) depicts, first electrode link 122a, second electrode link 122b, third electrode link 122c and a fourth electrode link 122d.

The electrode links are configured to communicate driving signals to the electrodes (to activate selected electrodes) from the driving module. The electrode links are further configured to communicate capacitance read out signals from the electrode (to the readout module).

In the present embodiment, the electrode links of the sensor module are embedded in a layered structure of the sensor module. Each electrode link has first and second connectors (also referred to as terminals) and a connecting portion between the first and second connectors. For clarity, the first connector 123, the second connector 126 and the connecting portion 125 are depicted in FIG. 4(a) for first link 122a.

The links are provided in the module in accordance with a link pattern such that the first connectors of the four links are aligned at a first end of the module and the second connectors of each electrode link terminates at the respective electrode. The link pattern is such that the connecting portions of each link do not overlap or crossover. It will be understood that when forming part of a sensing apparatus, further connections (for example, wiring or cabling or wireless capability) will connect the electrode links to the readout and driving module, in particular, the connectors

FIG. 4(b) depicts a cross-sectional view of the sensor module 124 at an electrode region. As depicted in FIG. 4(b), the sensor module has a layered structure. At the region of the electrode, the sensor module has a sealing layer 142, an isolation layer 144, an electrode layer 146 and a protective substrate layer 148. The layers are provided on a base substrate 140. The base substrate, in this embodiment, is made of silicone.

Channels for electrode links are provided in the isolation layer 144. In the present embodiment, the channels are microchannels and are formed in the isolation layer 144 using a laser engraving process the channels are engraved on the isolation layer by a laser machine.

FIG. 4(c) depicts an alternative view of the layered structure of part of the sensor module. FIG. 4(c) depicts electrode links 122 provided embedded in isolation layer 144. FIG. 4(c) further depicts electrode 114 formed in electrode layer. FIG. 4(c) also shows protective substrate layer and sealing layer. FIG. 4(c) also depicts holes 150 formed in isolation layer 144. The holes 150 are vertical interconnect holes. Each hole provides an opening for connecting the electrode layer to the electrode link.

The first and second connectors and electrodes may be formed of conductive and deformable materials, for example, a stretchable conductive materials. In the present embodiment, the electrodes are carbon black (CB) dispersed elastomers. It has been found that this material may be less suitable for the connectors and connecting portions of the electrode links due to its high resistance and non-linear, irreversible conductivity response under deformation. In the present embodiment, Eutectic Gallium 75.5% Indium 24.5% (EGain) is employed for the electrode links (the wires and connectors) due to its conductivity properties (3.4×10⁷ S m-1) and stable response to deformations In further detail, the 4-electrode sensing module has dimensions of (20×20×120 mm) consists of 4 different functional layers, i.e. the protective substrate layer 148 (about 0.39 mm thick), the electrode layer 146 (about 0.08 mm), the isolation layer 144 (about 0.24 mm thick) and the sealing layer (0.3 mm thick). Microchannels for wires (0.5 mm width) were engraved and connections (3×2 mm) on the isolation layer were formed by engraving by a laser machine, after which the sealing layer is bonded to the outward surface of the isolation layer. The EGain ink is injected into the channels with a small syringe. The connections between CB electrodes and EGain wires are ensured by vertical interconnect holes. While thickness are provided above, it will be understood that these thicknesses may be varied.

The above selection of materials and design parameters provide a relative capacitance response of a 40% strain ranges from 16% to 19%, depending on the activated electrode pairs. The response curves show excellent linearity and consistency over multiple cycles (more than 500 cycles). The EGain wires were shown to provide superior performance to CB wire counterpart in terms of sensitivity (more significant responses under the same deformations), linearity (no distortions in response curves) and cycling stability (does not shift after 500 cycles of stretches).

While FIGS. 2 and 4 show a sensing device made from sensing modules, in accordance with an embodiment, it will be understood that design parameters of the sensing device and/or module can be varied. The design depicted in FIG. 2 balances reconstruction performance against fabrication complication. The sensing module of FIG. 4 can be manufactured using known elastomer processing technologies to provide patterning accuracy, repeatability and scalability. Using these manufacturing techniques, sensing modules may be manufactured in parallel.

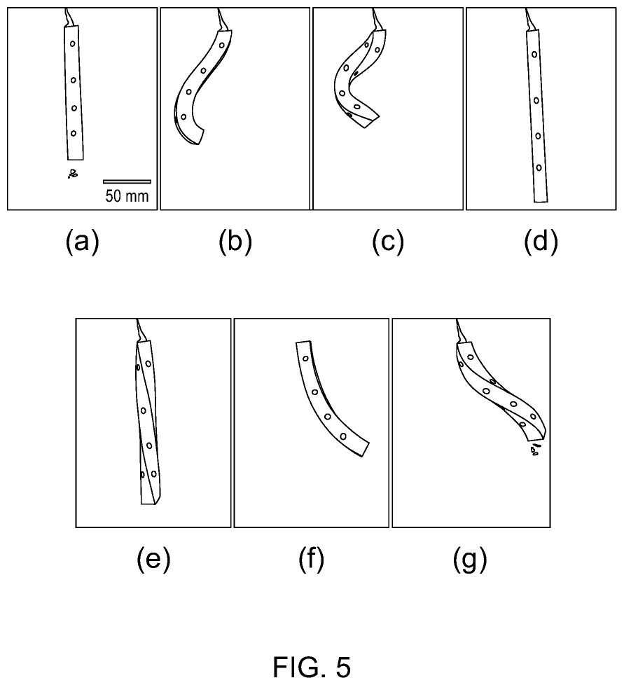

FIG. 5 depicts a representative set of deformations that can be sensed using sensing device. These deformations represent a non-limiting set of deformed states for the sensing device 112. FIG. 5(a) shows sensing device 112 in an undeformed state. The undeformed configuration may be referred to as the natural state of the sensing device 112. FIG. 5(b) show sensing device in a bent state, under the influence of a bending deformation. FIG. 5(c) shows sensing device undergoing bending and twisting deformations and is in a bent and twist state. FIG. 5(d) depicts the sensing device undergoing a elongation deformation (stretching) and is depicted in an elongated or stretched state. FIG. 5(e) depicts the sensing device undergoing elongation and twisting and is in an elongated and twisted state. It will be understood that these Figures are non-limiting examples of deformed states and under the influence of a force, the sensing device may be placed in a number of different deformed states. For example, FIGS. 5(f) and (g) depict further bent and/or bent and twisted states for the sensing device. As illustrated by FIG. 5, clearly the sensing device can experience and sense multi-modal deformations. The sensed deformation may include one or more of: bending, twisting, elongation, expansion, compression, tensile, shearing. It will be understood that infer the type of deformation of the sensing device.

FIG. 6 is a flowchart describing, in overview, a method of obtaining deformation information using capacitance signal output from the sensing device. Method 600 uses a trained model. The trained model may also be referred to as a capacitance to deformation transformer (C2DT). The training of the model is described with reference to FIG. 7. It will be understood that, in some embodiments, more than one trained model may be used.

At step 602 capacitance signal output data is obtained. As described above, the capacitance signal output data is obtained using the sensing device, in accordance with embodiments. At step 604, a trained model is applied to the capacitance signal output data. In the present embodiment, the capacitance signal output data is provided as an input to the trained model. At step 606, deformation information is obtained as an output from the trained model. Further detail on a specific neural network implementation of the model is provided with reference to FIG. 8.

FIG. 7 is a flowchart describing a method 700, in overview, of training a model for use in, for example, method 600.

At step 702, capacitance signal output training data is obtained. The capacitance signal output training represents capacitance signal output from the sensing device, as described in embodiments. The obtained capacitance signal output data is obtained for one or more spatial configurations of the plurality of electrodes and/or in response to one or more deformations applied to the deformable object. At step 704, deformation information training data is obtained. The deformation information training data corresponds to the obtained capacitance signal output data, and together, the two data sets provide a training data set. While steps 702 and 704 are described as two steps of method 700, they may also be considered as a single step of obtaining training data.

While the training data may be obtained using a number of different methods, in the present embodiment, the training data is obtained by applying a test deformation to the sensing device and measuring the corresponding capacitance signal output data for the deformation, as described with reference to, for example, FIG. 1. While the sensing device is under the test deformation, depth data of the sensing device is obtained using one or more depth sensing cameras situated about the sensing device. In the present embodiment, the depth data comprises or is processable to obtain 3D point cloud data.

The depth data is processed to obtain deformation information. In the present embodiment, multiple depth cameras (which provides 3D point cloud data) are used to capture the deformation. The depth data is processed and cleaned to be used as the ground truth in training.

The above process is then repeated for a number of test deformations to form a training data set that includes capacitance signal output training data and corresponding deformation information training data.

At step 706, a model training process is performed to train a model using the training data, in accordance with one or more model training algorithms. While a number of different training algorithms may be used to obtain a sufficiently trained model for use in, for example, method 500, as a non-limiting example, the training process includes providing the capacitance signal output training data as an input to the model and performing a comparison the output of the model to the deformation information training data. By iteratively providing capacitance signal output training data to the model and comparing the output to the deformation information training data, values for the model weights are refined, thus training the model.

At step 708, the trained model is stored. The trained model is stored for use, for example, during method 700. While the training may be performed on a further processing resource to that of the sensing device, the trained model or at least the trained weights may be stored on memory resource 22 for use by the sensing apparatus.

While FIGS. 6 and 7 depict, in overview, methods of training a model and using a model for obtaining deformation information, FIG. 8 depicts, in further detail, a model architecture for a neural network model, in accordance with an embodiment.

The model takes capacitance readout data 704 as a first input and a source point cloud as a second input 706. The input source point cloud provided as input corresponds to a source point cloud for the un-deformed sensing device. The input source point cloud therefore comprises spatial information corresponding to, for example, the shape and volume of the sensing device. The model is trained to output a reconstructed target point cloud based on the inputs. In overview, the model displacement of each point in the source point cloud (without any deformations) from the capacitance readout data.

The transformer can be considered to have three modules (also referred to as layers: an encoding module 710; a decoding module 712 and a loss counting module 716.

The encoder module receives capacitance signal readout data 704 as an input. The features from capacitance data are extracted based on a self-attention mechanism. The features are then fed into the decoder part to ‘deform’ the source point cloud. In the encoding part, the neural network encodes the input capacitance readouts and the geometrical structure information of electrode pairs to a high-dimensional space and feeds them to the transformer encoder to distil proprioceptive information.

The decoder module receives source point cloud data 702 and the output of the encoder as inputs. In use, the trained decoder module outputs reconstructed target point cloud data 708. In the decoding part, the network manages to assign a correct displacement to each point in the source point cloud based on the output sequence of the encoding part.

The loss counting module is used during training of the model. As part of the training process, ground truth of target point cloud (also referred to as training data) is provided to the loss counting module. The loss counting module 714, is used for training the model. The loss counting module 714 include a loss function that is minimized during the training process. The loss function consists of a squared distance term for visual markers and a Chamfer distance term for the remaining points.

It will be understood that the neural network of FIG. 8 is an optimised structure for this specific problem, however, other suitable network structures and models may be used.

In addition, it will be understood that for different applications (for example, for determining different types of further information from the capacitance signals), different trained models will be used. As such, for a particular application, the processing resource 20 can be configured to retrieve the appropriate model information (for example, model weights and/or other model data) from memory resource 22. For example, for the shape reconstruction purpose, a trained shape reconstruction model is obtained and used. As a further example, to determine type of deformation, a trained model is obtained that converts capacitance signal output into a label corresponding to the type of deformation.

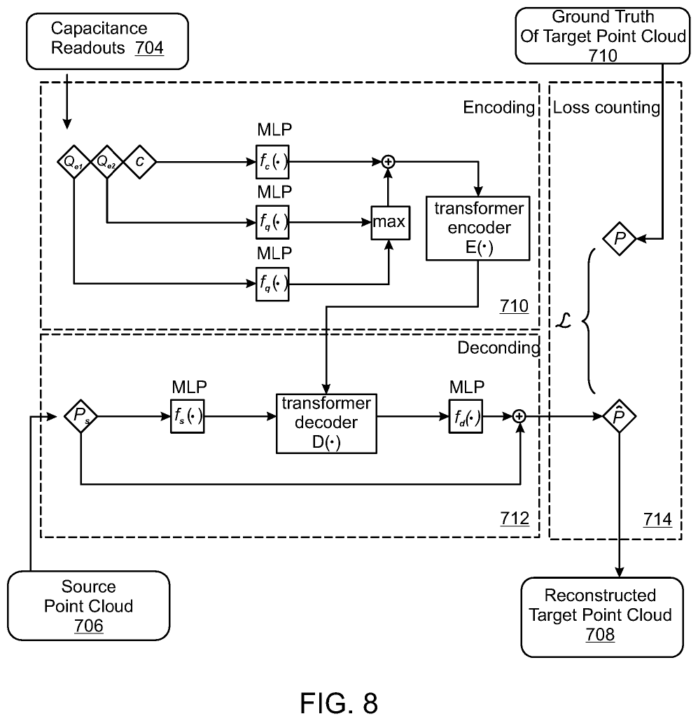

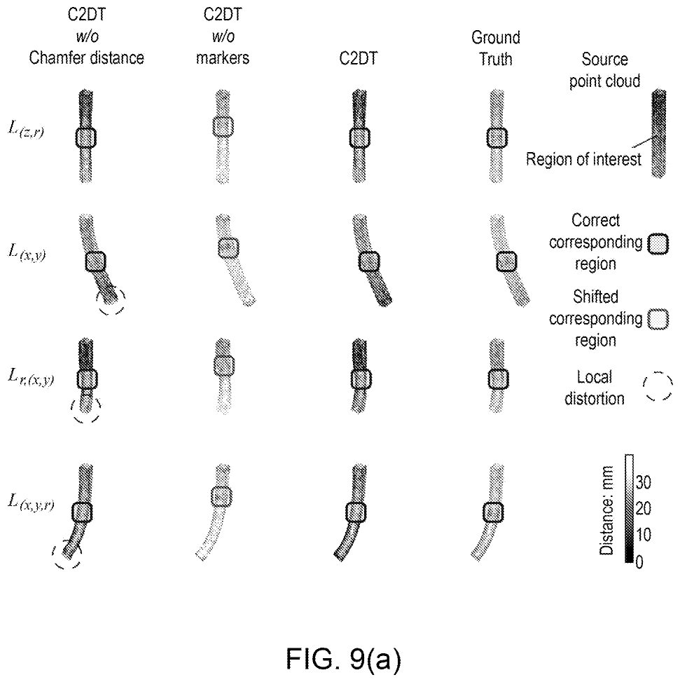

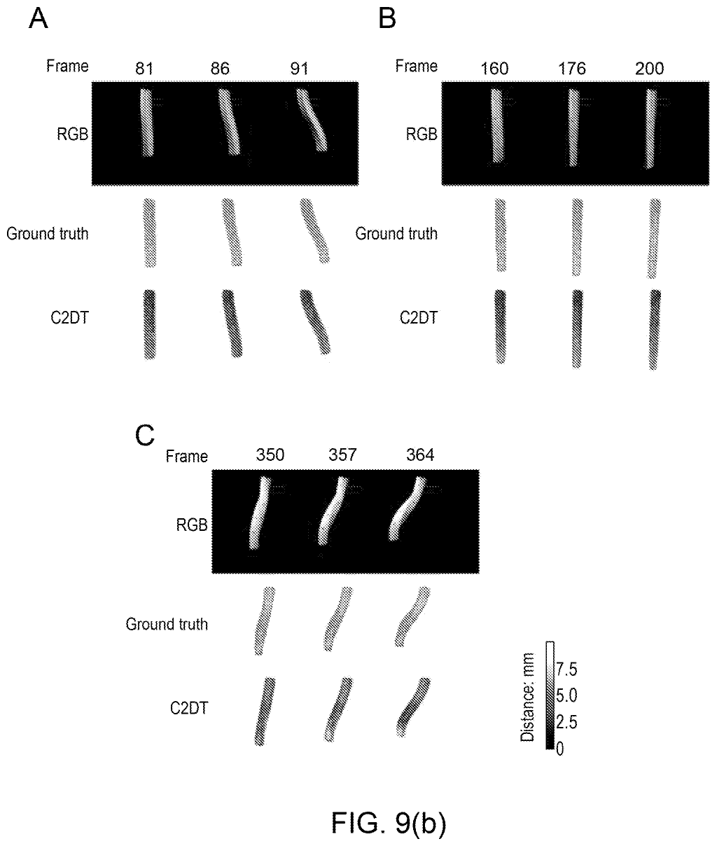

FIG. 9(a) depicts examples output graphical representation from a shape reconstruction process. These representations are generated using different trained models from sensed capacitance values. The region of interest is the middle section in the source point cloud. The reconstruction results of the trained model represent good, high quality reconstructions and captured the range of complex deformations tested (as measured by a number of performance metrics: the average distance (AD), the maximal distance (MD), the Chamfer distance, Hausdorff distance). The impact of the visual marker term in the loss function is analysed as part of the analysis.

While FIG. 9(a) depicts simulation data, FIG. 9(b) depicts examples of real-world data. FIG. 9(b) depicts different frames of image data and the corresponding ground truth and trained model (C2DT) output for three different types of deformations.

The sensing device and methods described above offer advantages over known methods. For example, high-definition shape reconstruction and/or accurate determination of dimensions may be performed.

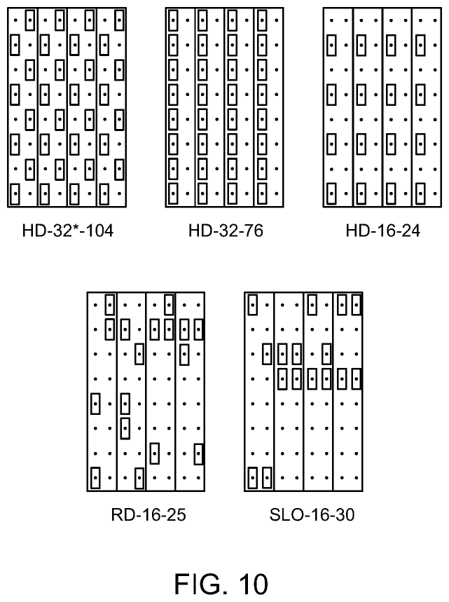

In further embodiments, dense electrode arrays may be used to meet the requirements of real-world applications. An increase in density of electrodes may lead to increase the burden of wiring, data collection and computation. In some scenarios, such as tactile detection at a large scale, sparse electrode arrays may be more preferable. In further embodiments, electrode layouts are determined using a trained machine learning algorithm. FIG. 10 depicts five different electrode layouts deployed on the surface of a soft rectangular body. The first three layouts are human designed (HD). The last two layouts are randomly generated (RD) and designed by machine learning algorithms using sensor layout optimisation (SLO).

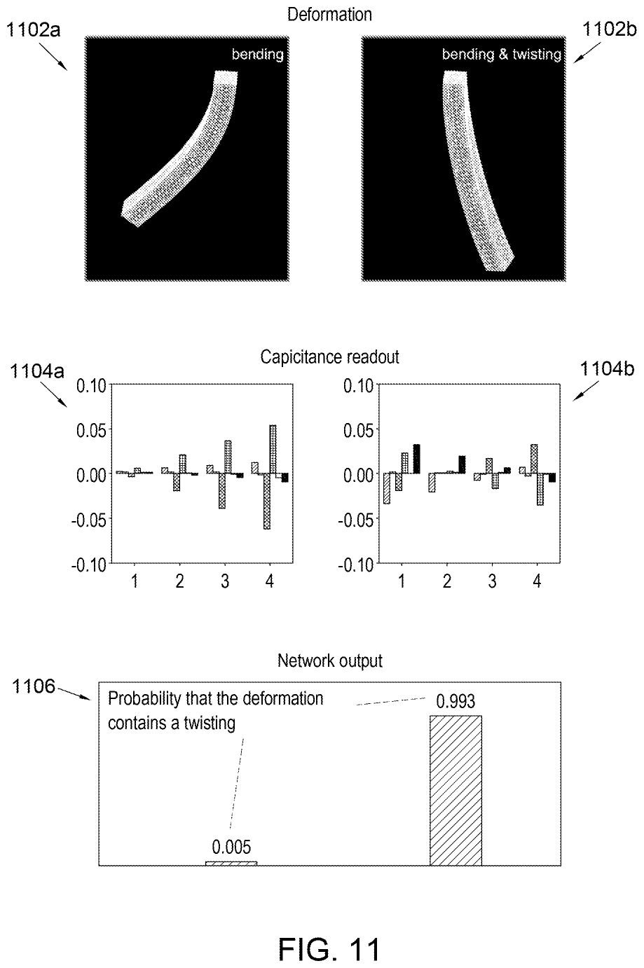

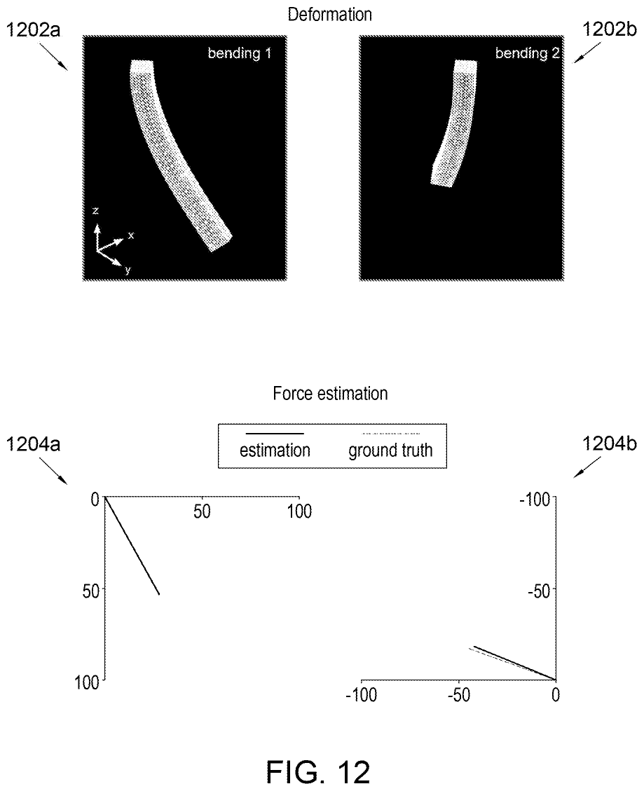

In the above embodiments, shape reconstruction and deformation sensing was described, in which an output of a trained neural network was, for example, a 3D point cloud or other spatial representation of the object. FIGS. 11 and 12 depicts results relating to other applications of the sensing device in which a neural network is trained to receive capacitance signal output from the plurality of electrodes as input and provide different types of output.

FIG. 11 depicts results relating to a deformation classifier. FIG. 11 depicts image data for two types of deformation: first image 1102a for a bending force applied to the object and second image 1102b for a bending and twisting force applied to the object. The capacitance signal readout is depicted for both types of deformation: first capacitance signal readout 1104a for the bending force and second capacitance signal readout 1104b for the bending and twisting force. The x-axis represents the index of the electrode layer (for example, see the layer structure of FIG. 2(c). In this embodiment, there are four layers and each layer has 4 electrodes leading to 6 capacitance readouts. The y-axis represents a measurement of calibrated capacitance. With regard to parameter estimation, in this embodiment, there is no need to deploy a dense array of electrodes.

FIG. 11 further depicts the network output. In this embodiment, the network output is a probability score that the applied force contains a twisting. For the first deformation (without twisting) the probability is 0.005 and for the second deformation (including twisting) the probability is 0.993. In some embodiments, a threshold on the output probability may be used to convert the probability to a binary value or the network may be trained to output a binary value.

FIG. 12 depicts results relating to a force estimation network. FIG. 12 depicts a first image 1202a for a first bending applied to an object and a second image 1202b for a second bending applied to the object. FIG. 12 also depicts the corresponding output from a trained neural network. The trained neural network for this application is trained to receive capacitance signal output from the plurality of electrodes as input and to output a size of force applied to the object. As is observed from results 1204a and 1204b, the estimated force closely relates to the ground truth measured force.

In the following, an experimental approach using the embodiments described above is described. The above-described embodiments relate to a technology to endow highly compliant systems with 3D proprioception enabled by a new type of intrinsically stretchable e-skins and advanced machine learning algorithms. The e-skins with their uniquely designed planar stretchable electrode arrays and sensing scheme may be able to capture the boundary deformation across the soft body. By leveraging the e-skin signals and a custom-designed deep neural architecture based on self-attention mechanism, it has been demonstrated that the proprioception system can uniquely reconstruct full 3D geometries under complex multimodal deformations in dense point clouds, with an accuracy (mm-scale errors) comparable to external commercial RGB-D cameras. This represents a step change over existing proprioception systems that only provide sparse geometrical inference under a constrained mode of deformations. The proprioceptive technology can equip soft robots with the capability to precisely perceive their kinematic states as natural creatures, thus paving the way of their employment in vital real-world scenarios, ranging from biomedicine to human-robot interaction.

A class of intrinsically stretchable capacitive e-skins (SCASs) embedded with planar electrode arrays to capture information, for example, 3D proprioceptive information is described. The SCAS is combined with a custom-designed deep net to reconstruct dense point clouds under complex multimodal deformations (which may be considered as one of the most challenging proprioception issues. The capacitance formed by the non-redundant combination of planar stretchable electrodes distributed on the 3D surface may characterize the boundary deformation and spatial electrical properties in the 3D domain of interest. Compared with parallel electrode arrays, the electrode array may have a more concise structure and may be easier to fabricate, miniaturize and modularize. A mock-up robot arm (a square cylinder silicone structure resembling of a stereotypical soft robot manipulator) actuated by external forces is selected as the testbed. This specific choice is motivated by computational simplicity in simulation and the need to test the widest range of possible deformations, which would not be achievable in an internally actuated system. However, the proposed approach is in principle agnostic to the shape of the soft body under investigation as it does not require any antecedent geometrical knowledge, making it generalizable to soft robotic platforms with a wide variety of geometrical configurations. The approach is first studied through electrostatics and solid mechanics coupling simulation and then transferred to the physical platform with appropriate electrode layout and network architecture modifications based on the conclusions drawn from simulation results.

In the coupling simulation, the SCAS consisting of 64 planar electrodes is deployed on a mock-up robot arm to characterize various deformations (elongation, twisting, bending and their combinations) caused by external forces via 392 measurable independent capacitance readouts at each measurement frame. A simulation dataset that includes 39,334 frames of different deformations (in point cloud format) and corresponding capacitance readouts is generated. The dataset is used to evaluate the performance of the SCAS and the 3D deformation reconstruction method. The results from the simulation phase serve the purpose of guiding the design of sensors and network architecture in the physical system.

Ablation studies are implemented to better understand the role of each loss term and position encoding. It was observed that the C2DT is unable to learn correct point-to-point correspondences without the inclusion of visual markers in the training process. The points in the region of interest in the source point cloud may not be mapped into the correct corresponding region when the reconstruction is performed by the C2DT without markers. The reconstructions may have similarities with the ground truth by minimizing the Chamfer distance term, whilst point-to-point errors remain large. It was also found that by retaining only the squared distance term of the visual markers during training, local distortions arise in a set of frames of the reconstructions. This indicates that the Chamfer distance term can benefit the geometrical quality of the reconstructions. Finally, poor convergence was observe when attempting to train the network after removing the position encoding part. It was observed that electrode pairs with high geometrical correlation tend to cluster together after the position encoding.

The high density of markers and electrodes of the SCAS employed in the simulation environment poses practical challenges to the fabrication and experimentation when applying it to the physical system. Therefore the impact of the number of markers and the electrode layout on the performance of the C2DT was investigated, with the ultimate purpose of guiding the design and deployment of a functional, real-world SCAS system. The results of this analysis, showed that the improvement in accuracy from increasing the number of markers plateaus. This provides evidence that a small set of visual markers may sufficient for the C2DT to establish correct point-to-point correspondences. Similarly, the reconstruction performance may improve with the density of electrodes, but the improvement is very limited after the number of electrodes exceeds a certain value (for example, above 32). Therefore, there appears to be a positive trade-off between reconstruction accuracy and electrode/markers units, confirming that it is safe to sacrifice a minute reduction in performance to drastically simplify the fabrication and deployment of the SCAS.

Eight 4-electrode SCAS modules were deployed on the surface of a mock-up robot arm with the size of 20×20×240 mm, which is one-fifth of the one studied in the simulation (the extra 40 mm in height is the interface area). The 32-electrode SCAS, consisting of the 8 SCAS modules, connects to an Electrical Capacitance Tomography (ECT) system to extract individual capacitance values. Two RGB-D cameras were used and placed directly opposite to capture real-time, ground-truth 3D deformations of the measured object as colour point cloud format from two complementary views and fuse them in one coordinate system. The sides of the mock-up robot arm were dyed white as its original transparency may negatively impact the quality of data collected by RGB-D cameras. Sixteen yellow visual markers are placed to encourage the network to learn correct point-to-point correspondences during training. The entire experiment platform, can synchronously record the capacitance and point cloud data at about 30 fps.

The reliability of the SCAS allowed the capacitance readouts frames (each frame comprises 76 independent readouts) to be recorded when the mock-up robot arm is deformed by hand manipulation of the bottom holder over a long period. About 1,220 s of deformation data was collected during a 10 h experiment.

A random sequence of complex deformations was implemented during the experiment, including bending, elongation, twisting and their combinations. In most frames, point clouds collected by cameras may not represent complete 3D deformations due to missing points caused by inevitable visual occlusion. These points may be filled by a shape reconstruction for the frames with slight missing point issues and directly filter the frames that face severe occlusion, after which a total of 31,380 frames of data were obtained.

Further challenges of experimental deformation reconstruction may come from the quality of point clouds (restricted by the accuracy of cameras, occlusion, light conditions), noise in SCAS signals, and imperfect synchronization between different devices. In order to compensate for these added sources of inaccuracy in the experimental setup, the C2DT framework by increasing the number of input frames (Ni adjacent frames of SCAS readouts) and by introducing a regularization term in its loss function that can limit the amount of change in distances between neighbouring points before and after deformations. Several C2DTs were trained with different input frame numbers using the filtered real-world dataset. The reconstruction performance was found to be improved improves as the input frames number increases and achieves its minimum error with 3 adjacent input frames. The improvement may indicate that increasing the number of input frames can reduce the negative impacts of noise in SCAS signals and asynchronization between different devices. The temporal correlations among adjacent frames may be considered to benefit deformation reconstruction. The results achieve a comparable level of quality with the ground truth point clouds collected by external RGB-D cameras.

According to the results of the ablation studies, visual markers play a similar role in both real and virtual environments, encouraging the network to learn correct point-to-point correspondences. It was also observed that the addition of the neighbour regularization term may slightly improve the reconstruction quality. The position encoding part is crucial to extract useful proprioceptive information from physical SCAS signals. In analogy to its contribution in the simulation, the position encoding can assign discriminative high-dimensional representations to different electrode pairs based on their geometrical structures.

The proprioception system described may capture real-time (30 fps) 3D geometries of various complex deformations with comparable quality (mm-scale error) to that of commercial RGB-D cameras. This may demonstrate significant superiority to many previous attempts that mainly involve primary and simple proprioception scenarios. The system may also be agnostic to the geometry of the measured object, thus may be extended to many other types of soft robots through a straightforward learning process with the aid of RGB-D cameras. The performance demonstrated by this technology offers great promise in tackling some of the most complex challenges in the control of soft robots, thus fostering their adoption in fields such as biomedicine and human robot interaction. In addition, the dynamic coupling field simulation approach that simultaneously incorporates sensors and soft robots deformation could be a powerful tool to facilitate automatic sensor design and optimization, for example, in the fields of such as the digital twins of soft robots. Improvement of the SCAS system presented here allows may also allow for the integration with other sensor units. Such integrated methods may allow multimodal sensing of both proprioception and external stimuli, further aligning the performances of artificial systems with those of living organisms. Without limitation, further description of simulation and experimental approaches are described in the following, in accordance with embodiments.

As part of the experimental investigation, a coupling simulation is implemented in COMSOL Multiphysics to generate abundant capacitance and deformation data to demonstrate the effectiveness of proposed methods. The body of investigation is a square cylinder mock-up robot arm made of silicone (length: 271 mm, width: 100 mm, height: 1000 mm). An electrode array with 64 electrodes (8×8) is placed on the surface f the mock-up robot arm to form a 64-electrode SCAS. Each electrode is a 105×30 mm flat surface without thickness. The distance between two adjacent electrodes on the same side is 20 mm both horizontally and vertically. The distance from each edge and the nearest electrode is 10 mm. The relevant material properties are set as follows: Young's modulus E=4.15 MPa, Poisson's ratio v=275 0.022, density p=1.28×103 kg m-3, relative permittivity Sr=3.276.

In the simulation, 956 different episodes are implemented. Each episode mimics a time-continuous deformation process and is discretized into about 40 frames. In each frame, the deformation and the corresponding capacitance readouts from the SCAS are recorded.

Four different types of loads are applied to generate various complex deformations: 1. A combination of elongation and twisting L(z,r) in which a torsion force and a pulling force along the z-axis are simultaneously applied to the tip of the mock-up robot arm. 2. Pure bending L(x,y) in which a pulling force in the x-y plane is applied to the tip of the arm. 3. Two-phase twisting and bending Lₑ(x,y) in which a torsion force is applied on the arm's tip in the first r frames (r ranging from 6 to 16), and then a pulling force in the x-y plane is applied to the tip while maintaining the twisting state. 4. A combination of twisting and bending L(x, y, r) in which a torsion force and a pulling force in x-y plane are applied to the arm's tip at the same time. Each deformation is represented by a 3D point cloud with 1,716 points. Because it is impractical to ascertain the exact point-to-point correspondences of all points in real-world conditions across all deformations, a scenario can be realistically implemented in the physical experiment was used. 64 points as visual markers were selected, the correspondences of which are available during network training and the correspondences of the remaining points are only used in testing for evaluation.

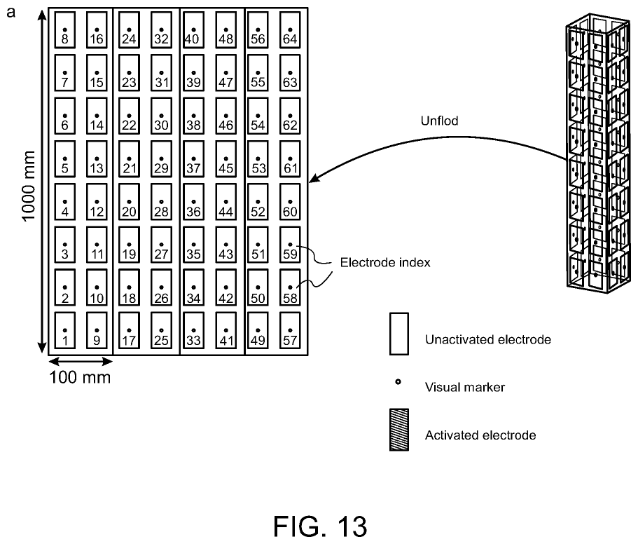

Theoretically, any two electrodes can form a capacitor. FIG. 13 depicts a sensing device with 64 electrodes in an assembled configuration (right hand side) and the disassembled configuration (left hand side). The SCAS with 64-electrodes (as shown FIG. 13) can produce 2,016 independent capacitance readouts in each measurement frame. However, many of them output extremely weak signals because of the long distance (e.g. the capacitance between electrode 1 and electrode 64). In a physical platform such signals would be hard to detect, making the case for disregarding them altogether. Therefore, only capacitances of electrode pairs in the same layer and capacitances of certain electrode pairs between two adjacent layers are recorded.

In particular, in this example, 28 electrode pairings in the first layer form measurable independent capacitors. The subset of pairings include the following independent (non-repeated pairings): electrode 1 forms a pairing with each electrode in the layer (9, 17, 25, 33, 41, 49 and 57) to give 7 pairings; electrode 9 forming additional pairings with all electrodes in the layer expect electrode 1 (17, 25, 33, 41, 49, 57). It will be understood that in this scheme, electrode 25 forms 4 additional pairings (with electrodes 33, 41, 49 and 57); electrode 33 forms 3 additional pairings (with 41, 49, 57); electrode 41 forms 2 additional pairings (with electrode 49 and 57) and electrode 49 forms 1 additional pairing (with electrode 57).

In particular, in this example, 24 electrode pairings between first and second layers form measureable independent capacitors. The subset of pairings include the following independent (non-repeated pairings): electrode 1 forms a pairing with each electrode in the layer (9, 17, 25, 33, 41, 49 and 57) to give 7 pairings; electrode 9 forming additional pairings with all electrodes in the layer expect electrode 1 (17, 25, 33, 41, 49, 57). It will be understood that in this scheme, electrode 25 forms 4 additional pairings (with electrodes 33, 41, 49 and 57); electrode 33 forms 3 additional pairings (with 41, 49, 57); electrode 41 forms 2 additional pairings (with electrode 49 and 57) and electrode 49 forms 1 additional pairing (with electrode 57).

24 electrode pairs between the first and second layers form measurable independent capacitors. In total, the SCAS can generate 392 independent capacitance readouts per measurement frame. For the first layer, each electrode forms 3 additional pairings with adjacent electrodes in the second layer. For example, electrode 1 in layer 1 forms pairings with adjacent electrodes 2, 10 and 58 and electrode 9 forms additional pairings with adjacent electrodes 2, 10 and 18. It will be understood that each electrode forms 3 additional pairings.

In total, the SCAS can generate 392 independent capacitance readouts per measurement frame. Each readout is calibrated as follows: c=(c′−cₑₘₚ)/cₑₘₚ, where c is the calibrated capacitance readout, c′ is the original readout and cₑₘₚ is the readout without deformation. A total of 39,334 frames (956 episodes) of deformations and capacitance readouts are produced through the coupling simulation, of which 2,319 frames (53 episodes) are with deformation type 1, 12,552 frames (300 episodes) are with deformation type 2, 12,269 frames (303 episodes) are with deformation type 3 and 12,194 frames (300 episodes) are with deformation type 4.

Deformation recovery from the SCAS sensing data is actually a sequence-to-sequence problem, mapping a capacitance readout sequence to the corresponding point coordinate sequence (point cloud). As described above, a capacitance-to-deformation transformer (C2DT) with self-attention mechanisms may be used to achieve dense 3D deformation reconstruction. In the following additional comments regarding the architecture, details of the implementation and evaluation metrics of the C2DT are described in accordance with embodiments.

In general, the C2DT is a deep model which is able to deform the source point cloud P_{S} to the reconstruction of the target point cloud \hat{P} according to the measurement characteristic tensor (c, Qₑ_{₁}, Qₑ_{₂}). Here P_{S}∈ [symbol] ^{N}^{ₚ}^{×3} is the point cloud without any deformations, Nₚ is the number of points in P_{S}, and the value is 1,719 in this case; \hat{P}∈ [symbol] ^{N}^{ₚ}^{×3} is the reconstruction of the point cloud with a specific deformation; ĉ∈ [symbol] ^{N}^{ₘ}^{×3} is the corresponding calibrated capacitance readouts; Nₘ is the number of readouts in c with the value of 392 in this case; and Qₑ_{₁}∈ [symbol] ^{N}^{ₘ}^{×3} and Qₑ_{₂}∈ [symbol] ^{N}^{ₘ}^{×3} are the coordinates of electrodes to generate c.

The C2DT architecture mainly consists of two parts, i.e. encoding and decoding. The input of the encoding part is c, Qₑ_{₁}, Qₑ_{₂}. Qₑ_{₁} and Qₑ₂ are considered as positional signals that can help to distinguish different elements in c. They pass through the multi-layer perceptron (MLP) f_{q} to obtain the geometrical representations of individual electrodes. An element-wise max function is selected to integrate the two electrode representations to the final geometrical representations for electrode pairs as the capacitance is independent of the order of electrodes (i.e. the capacitance readout between electrode 1 and electrode 2 is the same with the readout between electrode 2 and electrode 1). The MLP f_{c} maps c to high-dimensional representations, and the sum of capacitive and geometrical representations is the input sequence of the transformer encoder E with the length of Nₘ.

For the decoding part, P_{S} is fed to the MLP fₛ first, and then multi-head attention is implemented over the outputs of fₛ and E through the transformer decoder D. The MLP f_{d} is used to map the output sequence of D(•) to the displacement of each point, and the reconstruction P is obtained by adding it to P_{S}.

P is expected to be as close as possible to the ground truth of the target point cloud P. This goal is achieved by minimizing the following loss function:

$$ℒ = {𝔼}_{P ∼ 𝒫} [ {λ}_{1} {\underbrace{{\sum }_{i = 1}^{{N}_{v}} {\vert {p}_{v}^{i} - {\hat{p}}_{v}^{i} \vert}_{2}^{2}}}_{squared distance} + {λ}_{2} {\underbrace{{\sum }_{j = 1}^{{N}_{r}} ( {min}_{{p}_{r} ∈ {P}_{r}} {\vert {p}_{r} - {\hat{p}}_{r}^{j} \vert}_{2}^{2} + {min}_{{\hat{p}}_{r} ∈ {\hat{P}}_{r}} {\vert {p}_{r}^{j} - {\hat{p}}_{r} \vert}_{2}^{2} )}}_{Chamfer distance} ]$$

where Pᵣ∈ [symbol] ^{N}^{ᵣ}^{×3} represents the remaining points; pᵣ^{j}∈ [symbol] ³ is the Coordinates of the jth remaining point; pᵣⁱ∈ [symbol] ³ is the coordinates of the ith visual marker; Nᵥ and Nᵣ are the numbers of the visual markers and the remaining points respectively; [symbol] is the distribution of P; λ₁ and λ₂ are the weights of the squared distance term of the visual markers and the Chamfer distance term of the remaining points respectively.

The structures of subnetworks of the C2DT are as follows:
fₛ: Linear(3, hₑₘ)->ReLU->LayerNorm(hₑₘ)->Linear(hₑₘ, d_{model})->ReLU->LayerNorm(d_{model})
f_{q}: Linear(3, hₑₘ)->ReLU->LayerNorm(hₑₘ)->Linear(hₑₘ, d_{model})
f_{c}: Linear(1, hₑₘ)->ReLU->LayerNorm(hₑₘ)->Linear(hₑₘ, d_{model})
f_{d}: Linear(d_{model}, 3)->α*Tanh
E: LayerNorm(d_{model})->Transformer.EncoderLayer(d_{model}, d_{ff}, h, P_{drop})⊗n_{e-layer}
D: Transformer.MutualLayer(d_{model}, d_{ff}, h, P_{drop})⊗n_{m-layer}->Transformer.DecoderLayer(d_{model}, d_{ff}, h, P_{drop})⊗n_{d-layer}
where
hₑₘ=32, d_{model}=128, α=1.2, d_{ff}=256, h=8, P_{drop}=0.1, n_{m-layer}=1, n_{e-layer}=3, n_{d-layer}=2.

Linear layers in f_{q} and f_{c} do not have learnable biases while others have. The LayerNorm in E takes the sum of capacitive and geometrical representations as input. Transformer.EncoderLayer and Transformer.DecoderLayer are exactly the same with the original transformer. The first self-attention cell of Transformer.DecoderLayer is removed and the remaining part as Transformer.MutualLayer is used because P_{S} remains constant. Transformer.EncoderLayer⊗n_{e-layer} represents a stack of n_{e-layer} Transformed.EncoderLayer.

The simulation dataset is split into three exclusive parts, i.e. training, validation and testing sets. The training set includes 22,517 340 frames (548 episodes), of which 1,334 frames (31 episodes) are with the first type of deformation; 7,204 frames (172 episodes) are with the second type of deformation; 6,980 frames are with the third type of deformation (173 episodes) and 6,999 frames (172 episodes) are with the fourth type of deformation. The validation set includes 9,721 frames (236 episodes), of which 550 frames (12 episodes) are with the first type of deformation; 3,093 frames (74 episodes) are with the second type of deformation; 3,098 frames (76 episodes) are with the third type of deformation and 2,980 frames (74 episodes) are with the fourth type of deformation. The test set includes 7,096 frames (172 episodes), of which 435 frames are the first type of deformation; 2,255 frames (54 episodes) are with the second type of deformation; 2,191 frames (54 episodes) are with the third type of deformation and 2,215 frames 3.5*(54 episodes) are with the fourth type of deformation.

The C2DT is implemented in PyTorch. The Adam optimizer is used (β₁=0.9, β₂=0.98, ϵ=10⁻⁹) to update learnable parameters and minimize the loss function. The initial learning rate of 0.001 is used, which is decayed by a factor of 1.2 every 15 epochs. λ₁ and λ₂ are calculated as follows:

$${λ}_{1} = λ / 3 ( λ {N}_{v} + 2 {N}_{r} ) , {λ}_{2} = 1 / 3 ( λ {N}_{v} + 2 {N}_{r} ) , where$$

$$λ = max ( 1 , 300 - 2 * ( epoch - 1 ) ) .$$

The gradient is clipped with the threshold of 0.5 and the C2DT is trained using the training set for 300 epochs with a batch size of 24. Each epoch takes about 9 min on 3 Nvidia Quadro P5000. The network with the least validation loss is saved as the final model.

The performance of the C2DT is evaluated through 4 error metrics, i.e. the average distance (AD), the maximal distance (MD), the Chamfer distance (CD) and the Hausdorff distance (HD).

$$AD = \frac{1}{{N}_{P}} {\sum }_{i = 1}^{{N}_{P}} {\vert {p}^{i} - {\hat{p}}^{i} \vert}_{2}$$

$$MD = {max}_{i ∈ [ 1 , {N}_{P} ]} {\vert {p}^{i} - {\hat{p}}^{i} \vert}_{2}$$

$$CD = \frac{1}{2 {N}_{P}} {\sum }_{i = 1}^{{N}_{P}} ( {min}_{p ∈ P} {\vert p - {\hat{p}}^{i} \vert}_{2} + {min}_{\hat{p} ∈ \hat{P}} {\vert {p}^{i} - \hat{p} \vert}_{2} )$$

$$HD = max ( {max}_{\hat{p} ∈ \hat{P}} {min}_{\hat{p} ∈ \hat{P}} {\vert p - \hat{p} \vert}_{2} , {max}_{p ∈ P} {min}_{\hat{p} ∈ \hat{P}} {\vert p - \hat{p} \vert}_{2} )$$

To understand the impact of each loss term and position encoding on the performance, ablation studies were implemented. The squared distance term and the Chamfer distance term are removed, respectively and the same training procedure is performed to obtain results of the C2DT w/o markers and the C2DT w/o Chamfer distance. An attempt to train the network without the position encoding part was unable to converge. The position representations of the trained C2DT may be visualized through t-SNE29, which can help to discover the geometrical correlation among different electrode pairs. The performance of C2DTs with different network hyperparameters, different numbers of visual markers and different electrode layouts was investigated using the same method to guide the sensor and network design in the real world.

A 32-electrode SCAS composed of 8 modular 4-electrode SCASs with 4 different functional layers, i.e. the protective substrate, the electrode layer, the isolation layer and the sealing layer was fabricated, in accordance with embodiments. Each module was fabricated layer by layer, as follows:
i. Smooth-on Ecoflex 00-30 part A (1.0) and part B (1.0) was mixed and then poured on a glass plate. A TQC sheen micrometer film applicator was used to flatten the silicone and cure it for 3 min in an oven at 100° C.
ii. An Imerys Enasco 250P conductive carbon black (0.2) with isopropyl alcohol (2.0) was mixed, after which the uncured silicone mixture (2.0) is added and stirred for 3 min. A layer of uncured conductive silicone is coated on the protective substrate and is cured for 3 min in a 100° C. oven.
iii. A 40 W Aeon MIRA 5 laser engraving and cutting machine was used to pattern CB electrodes. The parameters are set as follows: 28% 386 Power, 300 mm s-1 Speed and 0.05 mm Interval. The planar size of each electrode is 21×6 mm, which is one-fifth of the one studied in the simulation.
iv. The same method as (i) was used to fabricate a silicone membrane for the isolation layer on the top of the electrode layer.
v. Two rounds of engraving are performed with 20.5% Power, 300 mm s⁻¹ Speed and 0.05 mm Interval to generate micro 380 channels of liquid metal wires and connections to readout electronics. Four rounds of engraving are done with the same parameters to generate vertical interconnect holes. The planar size of readout connections and vertical interconnect holes is 3×2 mm, and the width of wires is 0.5 mm. The rectangular area of the modular SCAS is cut with 19.5% Power and 25 mm s⁻¹ speed and remove the remaining part.
vi, A new piece of silicone membrane is fabricated following step i, and uniformly coated with a very thin layer of uncured silicone mixture on its surface as adhesive. Then the cut SCAS formed in step v was attached on the top of the membrane and any trapped bubble manually squeezed out. After about 4 h room temperature curing, good quality bonding is obtained.
vii. Eutectic Gallium 75.5% Indium 24.5% (EGaln, Sigma Aldrich) ink from readout connections is injected through a syringe with a 0.33 mm needle, and the air in microchannels is exhausted through the vertical interconnect holes. Then uncured silicone mixture is used to seal the injection points.
viii. The final modular 4-electrode SCAS is obtained.

The planar size of the SCAS module is 120×20 mm, of which 100×20 mm is the area of the electrodes that is one-fifth of its counterpart in the simulation, and 20×20 mm is the interface area with readout electronics. The layer thicknesses are 0.39 mm, 0.08 mm, 0.24 mm and 0.3 mm, respectively. Because the fabrication is easy to scale up, 5 SCAS modules in parallel, in this example.

A square cylinder mock-up robot arm with the size of 20×20×240 mm which is one-fifth of the one in the simulation is cast. The extra 40 mm in height is the interface area employed for driving the deformation and bonding with the fixed ceiling. 8 4-electrode SCAS modules are bonded on to its surface to form the 32-electrode SCAS proprioception system. A silicone layer is coated with white Smooth-on Silc Pig Silicone Pigments for better reflection. 16 yellow dots as visual markers are attached, which are able to assist network training with correspondence information and cover the readout electronics interface with black acrylic tape to reduce its interference in point cloud collection.

To characterize the response of the SCAS module and demonstrate the superior performance of EGaln wires compared with CB wires, a 4-electrode SCAS with CB wires and a 4-electrode SCAS with EGaln wires on the front and back sides of a segment of the square cylinder silicone structure (20×20×140 mm) and cyclically stretch them using a Nema23 stepper motor with a SFU1605 ball screw. Each cycle takes 20 s, and the SCASs are strained by up to 40%. The entire test takes about 3 hours (more than 500 cycles). Relative capacitance readouts of each SCAS were compared and it was shown that the SCAS with EGaln wires may have better sensitivity (larger response under the same deformation), linearity (no distortions in response curves) and cycling stability (does not shift after 500 cycles of stretches).

In experiments, an experiment platform consisting of the mock-up soft arm equipped with the 32-electrode SCAS, the readout electronics, two Microsoft Azure Kinect RGB-D cameras and a laptop to control the readout electronics and record data from the cameras and the SCAS. The readout electronics are based on a 32-electrode ECT system that supports arbitrary switching schemes. Its capacitance measurement resolution is 3 fF, and the signal to noise ratio of all channels is above 60 dB.

The two cameras are placed directly opposite and in a straight line with the mock-up robot arm to capture its real-time 3D deformations from two complementary views. The deformations are saved and represented via colour point cloud format. The cameras and the readout electronics synchronously record the data. The frame rate can reach about 30 fps if only the point cloud is recorded and capacitance data and decreases to around 20 fps if RGB images are recorded simultaneously.

During real-world experiments, the hand holder bonding to the bottom of the mock-up robot arm is manipulated manually to cause various complex deformations including elongation, twisting, bending and their combinations. At the same time, the SCAS and cameras synchronously record data (capacitance readouts, colour point clouds and sometimes RGB images) under the deformations. 36,465 frames (about 1,220 s) of data are collected in total, of which only capacitance readouts and colour point clouds are recorded in the first 36,013 frames (about 1,200 s), and extra RGB images are saved during the last 452 frames (about 20 s). The 32-electrode SCAS can produce 76 capacitance readouts in each frame which are calibrated using the same method as in the simulation. The point clouds from different cameras are fused in one coordinate system through the chessboard calibration method. The raw data is noisy and contains a lot of meaningless background points, making it unusable in this format for training purposes. The data are cleaned and pre-processed using Matlab and its computer vision toolbox to selectively retain only the points on the surface of the mock-up robot arm. The points on the black acrylic tape and red holders are eliminated via colour-filtering. In order to further reduce the negative impact of noise and outliers, regions whose local point densities are lower than a preset threshold are filtered. Due to inevitable visual occlusion occurring during experiments, the cleaned point clouds cannot completely represent 3D deformations in many frames. To obviate this issue, further preprocessing is required prior to training. An average grid downsampling with a 4 mm box gird filter at first for computational efficiency is implemented. Then a shapes are reconstructed on the basis of the downsampled point clouds to alleviate the issue of incomplete representation. The triangular meshes of the alpha shapes are subdivided three times, and vertexes are extracted as new point clouds with supplementary points. In the C2DT framework, the numbers of points in the source and target point clouds are expected to be the same. In order to meet this requirement, average grid downsampling is implemented with a 4 mm box gird filter and then use farthest point sampling to eventually select 1,300 points in each point cloud. Yellow visual markers are extracted from cleaned point clouds before downsampling and a shape reconstruction based on the RGB information of each point. A graph according to one frame of marker points is created. The connection of each two points in the graph determined by their distance. The threshold of connected distance is 6 mm. Each connected subgraph with more than 10 points is considered as a visual marker, and the average of the coordinates of all points in a subgraph is used to represent the marker position. The number of extracted visual markers is not always 16 due to camera occlusion. Visual markers are aligned layer to layer. The 16 visual markers can be divided into 4 layers, and each layer includes 4 markers. A graph based on one frame of coordinates of extracted markers with the connected distance threshold of 26 mm. Each subgraph is a layer of markers. The permutation of the layer is determined by the relative position in the y-axis of the fused coordinate system among all 4 layers. All abnormal frames for which the number of extracted markers is larger than 16 and/or the number of layers is not equal to 4 are deleted. The layers for which the number of markers is less than 4 are filled with (0,0,0) to ensure all layers have the same number of points, which can improve the computational efficiency during training. Furthermore, the frames with critically missing points issues because of the low quality of their reconstructed a shapes. The number of markers in individual layers indicates the severity of missing points. The frames with at least 2 markers in all layers are retained while others are dismissed. Upon the filtering process described above, a total of 31,380 frames of data still remains available for analysis. A random inspection of 500 frames out of the dataset is performed and samples with serious missing points issues were not found.

The basic framework of C2DT in the real-world experiment is analogous to the one in its simulation counterpart. However some modifications may be required due to the difference between real and virtual environments. First of all, the loss function in simulation is no longer applicable as in the experimental conditions described above, as there is no point-to-point correspondences of visual markers. Instead, a similar new loss function is used:

$${ℒ}^{*} = {𝔼}_{P ∼ 𝒫} \{ {λ}_{1} {\sum }_{k = 1}^{{N}_{l}} {\sum }_{i = 1}^{{N}_{tv}} [ d ( {p}_{{l}_{k}}^{- i} , {P}_{{l}_{k}} ) \cdot {S}_{r 2 g}^{k , l} + d ( {p}_{{l}_{k}}^{i} , {\tilde{P}}_{{l}_{k}} ) \cdot {S}_{g 2 r}^{k , l} ] + {λ}_{2} {\sum }_{j = 1}^{{N}_{r}} [ d ( {\dot{p}}_{r}^{j} , {P}_{r} ) + d ( {p}_{r}^{j} , {\dot{P}}_{r} ) ] + {λ}_{3} {\sum }_{j = 1}^{{N}_{r}} {\sum }_{l = 1}^{{N}_{n}} [ {( {\vert {\hat{p}}_{r}^{j} - {\hat{p}}_{r}^{j , l} \vert}_{2} - {δ}_{d} \cdot {s}^{j , l} )}^{2} \cdot {S}_{d}^{j , l} + {( {\vert {\hat{p}}_{r}^{j} - {\hat{p}}_{r}^{j , l} \vert}_{2} - {δ}_{u} \cdot {x}^{j , l} )}^{2} \cdot {S}_{u}^{j , l} ] \}$$

The first term of the loss function counts the Chamfer distance between the reconstruction and the ground truth of markers layer-by-layer, where Pₗ_{ₖ}∈ [symbol] ^{N}^{ᵢᵥ}^{×3} is the coordinates of the visual markers in the lₖ layer; Pₗ_{ₖ}ⁱ∈ [symbol] ³ is the coordinates of the ith point in Pₗₖ; d( [symbol] , Pₗₖ) is the squared distance between [symbol] , and its nearest point in Pₗₖ; Nₗ is the number of layers; Nₗᵥ is the number of marker in each layer and the values of Nₗ and Nₗᵥ are 4 in this case. When computing the loss, only the marker points extracted in the data preprocessing are considered and the padding points are ignored. All points in \hat{P}ₗ_{ₖ} are marker points as they are generated by the network based on the corresponding capacitance readouts and the source point which does not include padding points. In order to eliminate the effect of padding points during training, masks are synthesized as follows:
S_{g2r}^{k,i} set to 1 if pₗ_{ₖ}ⁱ is a marker point. S_{g2r}^{k,i} is set to 0 if pₗ_{ₖ}ⁱ is a padding point.
S_{r2g}^{k,i} set to 1 if Pₗ_{ₖ} does not include any padding points, otherwise S_{r2g}^{k,i} is set to 0.

The second term in the loss function is exactly the same as its simulation counterpart that counts the Chamfer distance between the reconstruction and ground truth of the remaining points. The third term is a regularizer which encourages the distance between neighbouring points to not change significantly before and after deformations. Here, \hat{p}ᵣ^{j,l} is the l^{th} is the neighbour of \hat{p}ᵣ^{j}; s^{j,l} is the distance between the corresponding two points in the source point cloud; δ_{d} and δᵤ are coefficients of thresholds. The loss is counted only if the neighbour distance in the reconstruction falls outside the preset range. This is achieved with masks as follows:
S_{d}^{j,l} is set to 1 if |\hat{p}ᵣ^{j}−\hat{p}ᵣ^{j,l}|₂−δ_{d}·s^{j,l}<0, otherwise S_{d}^{j,l} is set to 0.
Sᵤ^{j,l} is set to 1 if |\hat{p}ᵣ^{j}−\hat{p}ᵣ^{j,l}|₂−δᵤ·s^{j,l}<0, otherwise Sᵤ^{j,l} is set to 0.

The number of input frames in the physical world is not constant to 1. In contrast, the C2DT takes several (Ni) adjacent frames as its input. The first linear cell in fc is therefore modified to Linear(Nᵢ, hₑₘ). The hyper-parameters of the C2DT are set as: hₑₘ=32, d_{model}=64, d_{ff}=128, h=4, P_{drop}=0.1, n_{e-layer}=2, n_{m-layer}=1, n_{d-layer}=1 and α=1.9472.

The values of point cloud data are magnified five times to make it close to the simulation scale. The network is trained and evaluated using almost the same procedure as presented as described. The real-world dataset is split into three exclusive parts. The first 26,771 frames (about 1,020 s) are used for training (20,693 frames) and validation (6,018 frames), and the last 4,669 frames (about 200 s) are used for testing. δ_{d} is set equal to 0.5 and δᵤ is set equal to 2. λ₁, λ₂ and λ₃ are computed as follows:

$${λ}_{1} = λ / [ λ {\sum }_{k = 1}^{{N}_{l}} {\sum }_{i = 1}^{{N}_{lv}} ( {S}_{r 2 g}^{k , l} + {S}_{g 2 r}^{k , l} ) + 2 {N}_{r} ] ,$$

$${λ}_{2} = 1 / [ λ {\sum }_{k = 1}^{{N}_{l}} {\sum }_{i = 1}^{{N}_{tv}} ( {S}_{r 2 g}^{k , i} + {S}_{g 2 r}^{k , i} ) + 2 {N}_{r} ]$$

$${λ}_{3} = 1 / 10 [ {\sum }_{j = 1}^{{N}_{r}} {\sum }_{l = 1}^{{N}_{n}} ( {S}_{d}^{k , i} + {S}_{u}^{k , i} ) ]$$

where λ=max(1,300−10*(epoch−1)). In total, 200 epochs are run with a batch size of 39 and the network with the least validation loss is retained. Ablation studies are implemented to evaluate the effect of individual loss terms and quantitatively evaluate reconstructions on the real-world scale with CD and HD metrics which do not require point-to-point correspondences. Finally, the representations of individual electrode pairs are visualised via t-SNE to illustrate the geometrical correlation between different capacitance readouts.

In the above-described embodiments, obtaining a measurement for a selected pairing of electrodes involves activating a single electrode of the pairing and measuring capacitance at a corresponding single electrode of the pairing. In further embodiments, one or more of the selected pairings may comprise three or more electrodes. As a non-limiting example, such a pairing could involve a pairing between a first group of electrodes and a second group of electrodes. In operation, the first group of electrodes can be activated simultaneously to form a combined electrode and the second group of electrodes is also combined to form a corresponding combined electrode for measuring the capacitance. Examples of such multi-electrode sensing strategies that involve pairings of more than two electrodes are described, in the context of electrical capacitance tomography, in further detail in “A novel multi-electrode sensing strategy for electrical capacitance tomography with ultra-low dynamic range” by Yang. et al.

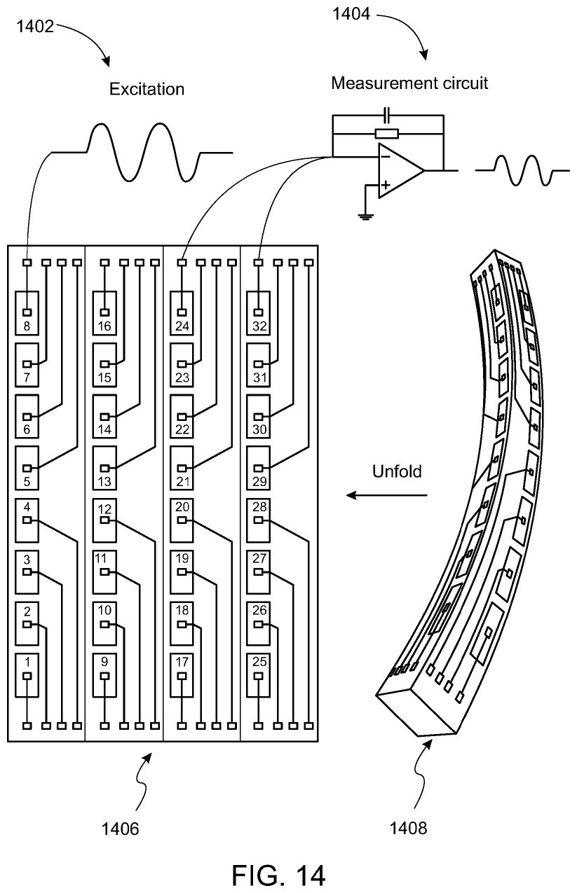

FIG. 14 schematically depicts a sensing apparatus in accordance with further associated embodiments illustrating combining groups of electrodes to form a pairing between a first group of electrodes and a second group of electrodes. FIG. 14 depicts excitation circuitry 1402 configured to apply an excitation signal to selected groups of electrodes and a measurement circuit 1404. FIG. 14 also illustrates a sensing device, in a disassembled configuration (1406) and an assembled configuration (1408), in accordance with embodiments. The excitation circuitry 1402 may be considered to form part of the driving circuitry and the measurement circuit 1406 may be considered to form part of a signal readout circuitry.

FIG. 14 depicts an equivalent capacitor that is the linear combination of a series of capacitors formed by two individual electrodes. FIG. 14 illustrates two electrodes (24 and 32) tied together to form a combined measurement electrode. In further detail, both electrodes are connected to the same terminal in the measurement circuit so that a capacitance of the combined electrode (24 and 32) can be measured by the measurement circuit. In FIG. 14, the capacitance formed by the example pairing of electrode 8 and the combined electrode 24 and 32 is equal to the capacitance between electrodes 8 and 24 plus the capacitance between electrodes 8 and 32, according to the principle of linear superposition: C_{8.24-32}=C_{8.24}+C_{8.32}.

In an example further embodiment, a 32-electrode multiplexer array is provided to allow suitable connections to be formed between the electrodes, signal readout circuitry and signal driving circuitry in order to form desired groups of electrodes. In this example embodiment, the 32-electrode multiplexer array allows each electrode to connect with one of an excitation circuitry (for receiving an excitation signal), a measurement terminal (of the measurement circuitry) or a ground terminal. The 32 electrode multiplexer array is controlled by control signal. The 32 electrode multiplexer array allows the electrode to be connected to one of the excitation circuitry, measurement circuit and ground terminal in response to receiving a control signal.

In further detail, a group of multiple electrodes may be excited simultaneously through the sensing device by controlling the multiplexer to connect each of the multiple electrodes to the excitation source simultaneously. Likewise, a further group of multiple electrodes could form a combined measurement electrode by controlling the multiplexer to connect each electrode of the further group to the measurement terminal. The multiplexer is further controlled to connect all other electrodes (all electrodes not in the first or second group) to the ground terminal. While a 32-electrode multiplexer array is described, it will be understood that other suitable signal routing circuitry may be used.

In such example embodiments, a specific combining electrode strategy may be designed and used. The electrode strategy may include sending control signals to the electrodes using the 32-multiplexer array or other signal routing circuitry. The control signals may comprise a sequence of digital signals, for example, control words to control the 32-electrode multiplexer array.

A skilled person will appreciate that variations of the enclosed arrangement are possible without departing from the invention.

For example, in the above-described embodiment, the electrodes are described as distributed about the surface of the object, however, it will be understood that in other embodiments, one or more electrodes may be embedded inside an object or at a depth from the surface of the object.

In the above described embodiments, the number of electrodes is 32. However, it will be understood that this number is not fixed. Indeed, the number of electrodes for a selected object may be in dependence on the complexity of the shape of the object or the size of the object (e.g. the larger the object, the more electrodes could be implemented).

In addition, while FIG. 1 depicts electrodes as part of the sensing device, it will be understood that other elements of sensing apparatus depicted in FIG. 1 may form part of the sensing device (for example, the driving module and/or readout module may form part of the sensing device. In some embodiments, the sensing device may comprise the driving module, electrode, readout module, processing resource and memory resource.

Furthermore, in the above described embodiments, sensing of capacitance signals is described. However, it will be understood that other types of electronic signal output may be sensed in further embodiments. For example, the signal output may comprise voltage and/or potential difference. In particular, the sensing device measures voltages. In some embodiments, the electrodes measure voltages that have a size (for example, an amplitude) having a linear relationship with the capacitance to be measured. In further embodiments, the sensing device could be extended to measure impedance. In some embodiments, the signals are all in the form of voltage and have since/cosine form with certain phase and/or amplitude, similar to modulated signals.

In the above described embodiments, learning-based approaches are described for full geometry reconstruction. While other methods may be used, very strong constraint and prior information would be essential and the model will usually be applicable to specific objects and lacks generalization ability. Learning based method may be practical to implement and generalized to different scenarios through an established training pipeline.

In addition or alternatively to sensing deformation and shape information, the sensing device may be capable to detect, for example, electrical properties and touch. For example, as described above, due to the nature of the capacitive electrodes, the capacitance values are sensitive to the permittivity change in a proximity distance near the skin surface. Therefore, objects approaching the skin will possibly cause permittivity change and thus affect the capacitance value. This characteristic could be used to sense the touch or, for example, collision detection.

A further embodiment is described in the following. The capacitance between two boundary electrodes may be represented by:

$$C = \frac{Q}{V} = - \frac{1}{V} {\int \int }_{Γ} ε ( x , y , z ) ∇ ϕ ( x , y , z ) d Γ$$

where C is the capacitance; Q is the charge stored; V is the potential difference between the boundary electrode pair; E(x, y, z) and ϕ(x, y, z) are the permittivity and potential distribution in the sensing domain and F represents the electrode surface. In contrast to other applications, when applied to soft robots, both the permittivity distribution and the geometry of the electrodes are subject to change which may increase the complexity to infer any desired information from obtained capacitance data. It has been found that permittivity distribution and geometry of boundary electrodes may trigger different patterns in capacitance measurements, making it possible to decode both tactile/touch and deformation information simultaneously. It will be understood that touch refers to approaching or contact of an object that causes a change in a property of the material between electrodes, in particular, a permitivity change in sensing areas.

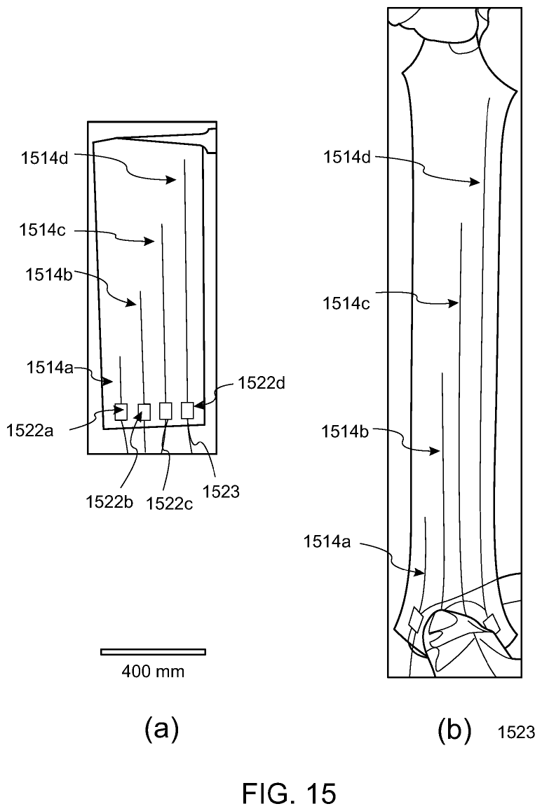

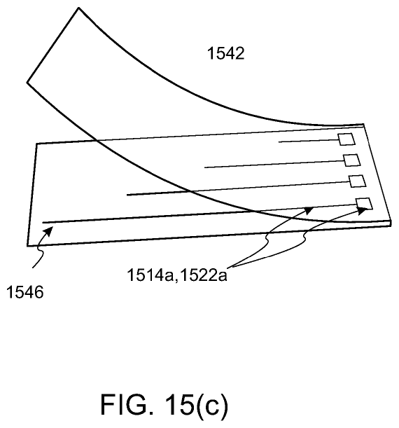

FIG. 15(a) show a sensor module (also referred to as an e-skin module) in accordance with a further embodiment. The sensor module of FIG. 15 has four electrodes: a first electrode 1514a, a second electrode 1514b, a third electrode 1514c and a fourth electrode 1514d. The sensor module is fabricated to be deformable under force, for example, stretchable, twistable and/or compressible. In particular, FIG. 15(a) depicts the module in a first unstretched and undeformed configuration and FIG. 15(b) depicts the module in a second, stretched or elongated configuration. In contrast to the sensor module of FIG. 4, which depicted electrodes, connectors and a connector link disposed in the material, in the embodiment of FIG. 15, the electrodes are liquid metal wires that have are substantially elongated along a first direction.

In the embodiment of FIG. 15(a), the electrodes are provided in a parallel arrangement and each electrode has a conductive portion that is elongated along a longitudinal direction of the sensor. FIG. 15(a) also depicts connectors (1522a, 1522b, 1522c, 1522d) for the electrodes. The connectors provide an interface between the liquid metal electrode and the respective metal readout wire. A metal readout wire 1523 is indicated for the fourth electrode 1514d and connector 1522d. In this embodiment, the electrodes are liquid metal wires and are provided together with connectors (also referred to as interfaces). In this embodiment, the size of the sensor module in the first (unstretched configuration) is 400 mm in width and 1100 mm in length. The widths of each electrode is 1 mm and the lengths are 20, 45, 70 and 95 mm, respectively. Each of the liquid-metal interfaces has an area of 5 by 5 mm.

The four liquid metal wires provide elongated conductive portions that are operable as electrodes, of which combinations can form capacitors, as described above. It will be understood that the sensor module is configured to be combined with one or more further sensor modules to assemble a sensing device, substantially as described with reference to the embodiment of, for example, FIG. 2.

As can be seen from FIG. 15(a), each of the four electrodes of the module has a different length and they arranged in a parallel arrangement. In this embodiment, each length is successively longer than the previous length. It will be understood that each of the electrodes of FIG. 15(a) has a conductive portion and is configured to perform a capacitance reading substantially along its length. The different lengths of each individual electrode may offer advantages for touch sensing, as the differences in lengths may increase differences in sensed capacitance signals, for example, when different areas of the module or sensing device are contacted.

As can be seen from FIG. 15(b), the sensor module is configured to be deformed and stretched in at least a longitudinal direction. The electrodes are disposed substantially parallel to the longitudinal direction. Stretching of the sensor module causes extension or further elongation of each electrode. In the first undeformed configuration, each electrode has a first length and in the second, deformed configuration, the electrode has a second, longer length,

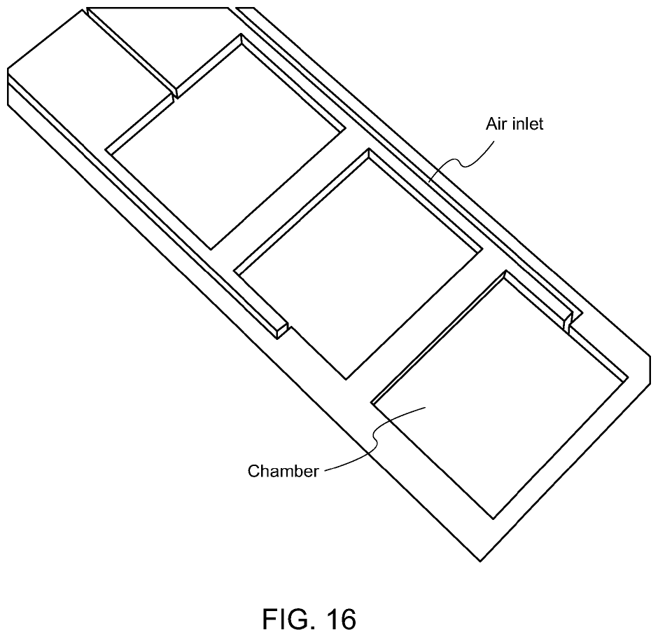

FIG. 15(c) depicts a layered structure of the sensor module of FIG. 15. FIG. 16 depicts the sensor module having two layers: a substrate layer 1546 and a protective layer 1542. The electrodes 1514a, 1514b, 1514c, 1514d and their corresponding connectors and interface are provided in the substrate layer 1546. FIG. 15(c) depicts the electrode layer and protective substrate layer together. The electrodes and interfaces are both provided in the electrode layer.

The electrode layer includes a substrate formed with platinum-catalyzed silicone. In the present embodiment, the platinum-catalyzed silicone is Ecoflex 00-30 silicone. Microchannels are fabricated in the substrate layer 1546 using a 3D-printing casting. Once the substrate is formed the protective layer 1542 is formed from a silicone membrane manufactured through film coating and is bonded to the substrate layer 1546 using uncured silicone as adhesive. Liquid metal ink is injected into the formed microchannel to form the sensing electrodes. In the present embodiment, the liquid metal ink is Eutectic Gallium 75.5%, Indium 24.5% (EGaln) ink and is injected from the interfaces. Air is exhausted through the ends of the wires. In contrast to the embodiment described with reference to FIG. 4(c) no carbon black electrodes are fabricated and therefore the number of layers are reduced to two. As can be seen from FIG. 15(b), the elongated conductive portions are embedded in the substrate such that the conductive portions can be deformed together with the substrate.

FIG. 16 depicts a 3-chamber pneumatic manipulator (sized 500 by 1200 mm) used as a testbed to verify the proposed methods. Pneumatic soft robots are frequently used in many applications and can provide different deformations, for example, inflation and bending. e.g., inflation and bending. The structure of the manipulator is shown in FIG. 16. The manipulator has three chambers, each measuring 400 by 300 mm and each chamber is served by an air inlet to allow air to be injected into each chamber. The width of each inlet is 1.5 mm. Two sensor modules, as described with reference to FIG. 15, are bonded to the external manipulator surfaces (one sensor module on the front and a second sensor module on the back) using uncured silicone as an adhesive. The two sensor modules together form an 8 electrode capacitive sensor as each module has 4 electrodes is capable of generating 28 capacitance readouts per measurement frame.

Non-limiting experimental methods and results are described in the following. In the following, a 3-dimensional vector p=(p1, p2, p3) is used to describe the inflation state of the robot, where p1, p2 and p3 are the volume of air injected into the first, second and third chambers, respectively. In the experiment, 20 ml of air is injected into each chamber of the robot simultaneously (i.e., p=(20, 20, 20) ml) and the sensor response signals are recorded.

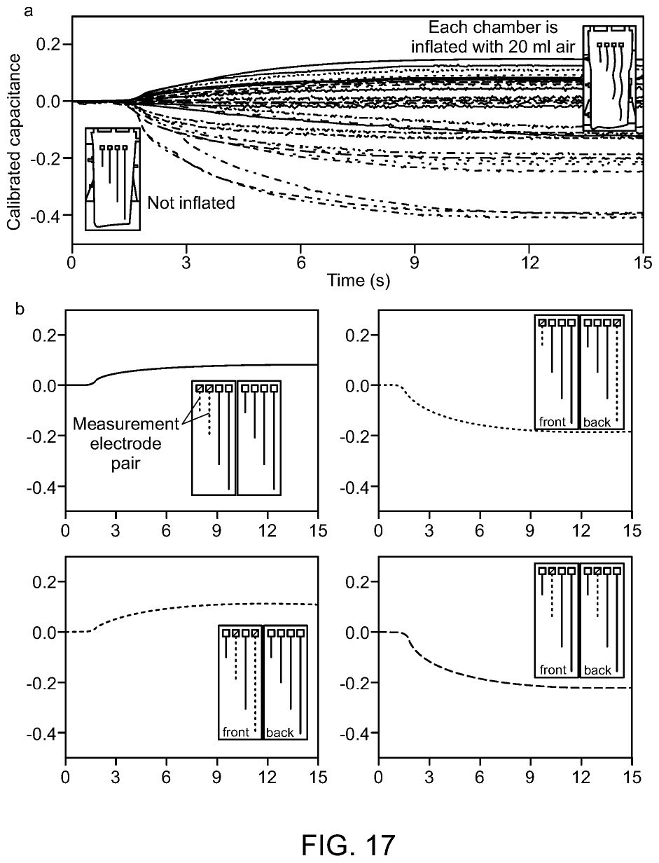

FIG. 17 shows results of measurements performed during such an inflation of the manipulator. FIG. 17(a) shows all 28 capacitance readouts during the inflation process. The y-axis is the calibrated capacitance C (i.e. a relative change in capacitance), which can be computed by:

$$c = \frac{{c}_{t} - {c}_{0}}{{c}_{0}}$$

where Cₜ is the capacitance readout in current state and C₀ is the capacitance readout in reference state (the state without inflation). The p=(20, 20, 20) ml inflation can stimulate a maximum variation of around 40% relative capacitance change. The capacitance readouts of capacitors formed by electrodes in the same surface typically increase as the pneumatic robot is inflated (examples are depicted in the left hand side of FIG. 17(b)). The capacitance readouts of capacitors formed by electrodes on different surfaces show the opposite trend (examples are shown in the right hand side of FIG. 17(b)). The inflation of the robot body makes the area of electrodes (positively correlated to capacitance) larger and the distance between electrodes (negatively correlated to capacitance) longer. For capacitors formed by electrodes on the same surface, the increase in the area of electrodes dominates the change in capacitance. For capacitors formed by electrodes on different surfaces, it was found that the variation in the distance between electrodes may be more significant and may dominate the capacitance variation.

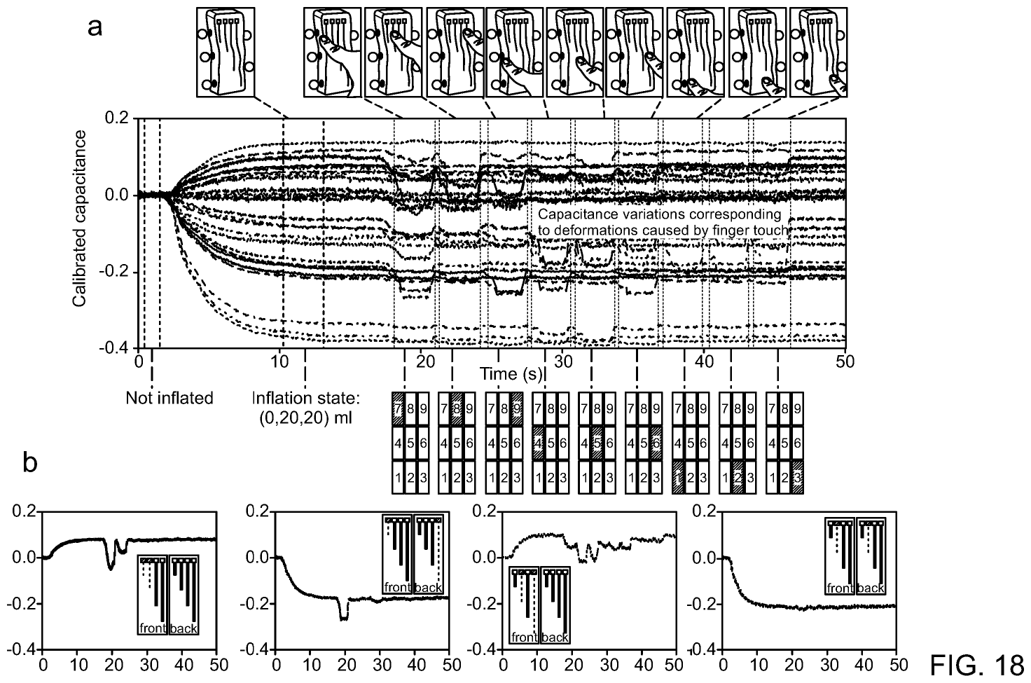

FIG. 18 shows results from a two stage experiment illustrating the difference in capacitance variation in response to touch and deformation. Capacitance variation in response to touch may be dominated by a permittivity variation. Capacitance variation in response to deformation may correspond to a geometry variation. Touch will induce permittivity change that will lead to further changes in the signal, according to the capacitance calculation equation. The same set of the electrodes to detect both touch and deformation but different signal patterns will be detected Touch may refer to as application of a local contact force on the surface of the sensor.

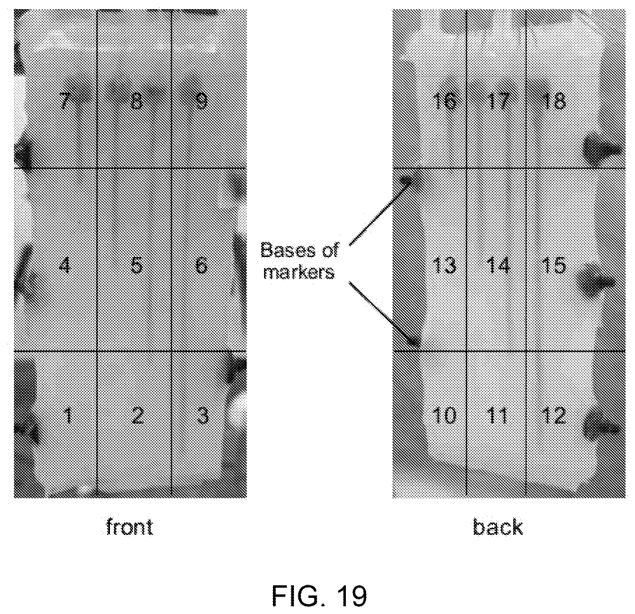

In the first stage, the robot is inflated to (0, 20, 20) ml without additional touch. The front surface of the robot is then divided into 9 parts (see FIG. 19) and each part is touched individually to form a touch measurement. Each contact may be referred to as a touch event or touch action and is performed at a contact location. FIG. 19 indicates the locations on the surface of the robot. In use, contacting one of the regions of the surface will result in the identification of the contact location on the surface. For example, a local contact in region marked 1 will return a label “1” from the trained model. It will be understood that more than one touch event or action at substantially the same time may be detected. While FIG. 19 depicts 9 touch regions, it will be understood that more electrodes may be used to provide higher distinguishablity and more touch regions.

FIG. 18(a) shows the overall response of the sensor. The capacitance response of the (0, 20, 20) ml inflation is similar to that of (20, 20, 20) ml inflation shown in FIG. 17(a) Inflation can trigger variations in every capacitance readout simultaneously (a global response) while touch only stimulates changes in a part of readouts based on the location of the touch point (a local response). Examples of capacitance readouts from four different electrode pairs are shown in FIG. 17(b). FIG. 17(b) illustrates that different electrode pairs have different perceptive fields. A capacitance readout only reflects the touch within its own perceptive field and is not sensitive to touches outside the area. This feature results in a different pattern in capacitance signals induced by inflation and touch. Small fluctuations in capacitance readouts during touch is also observed. This is induced by deformations of the robot body that are caused by touch/contact (for example, bending).

Further experiments are described in the following in which data is collected to verify the feasibility of recognising touch during deformation (for example, during inflation) using the proposed flexible sensor module. Ideally, it requires the location of the touch point and sensor signals simultaneously. However, it has been found that determining accurate touch (or contact) locations as the robot moves and deforms during the experiment poses significant challenges. Therefore, the surface of the robot is divided into 18 sub-regions (see FIG. 19). Sub-regions are then randomly touched in an experiment and the response signals recorded. The index of the sub-region reflects the coarse location of the touch point.

Furthermore, the possibility of extracting deformation information from the sensor signals is investigated, as deformation tracking is a critical topic, and sensing devices with multiple functions are desired in soft robotics. For the pneumatic robot platform, the inflation information is usually known, as the volume of air injected into the chamber can be controlled. Therefore, deformations caused by user interaction, such as bending induced by touch are investigated. To acquire deformation labels during the experiment, five reflective visual markers are bonded on the sides of the robot. Three OptiTrack Flex 13 cameras are then deployed around the robot to capture real-time 3D coordinates of the markers. The coordinates provide a brief description of the deformation and are used as deformation labels in the latter. The experimental platform includes the pneumatic robot equipped with the 8-electrode capacitive skin, as described above, together with five reflective visual markers, OptiTrack Flex cameras and readout electronics are used and can reach 3 fF capacitance measurement resolution and over 60 dB signal to noise ratio for all measurement channels). Data recording speed for the cameras and readout electronics is set to 30 fps.

Experiments were perfomed under 27 different inflation states ranging from (0,0,0) to (20, 20, 20) ml. In each inflation state, data are collected from 7 separate periods. Each period last 30 seconds. The robot is inflated to the preset state without touch during the first period. A sub-region of the robot is randomly touched to induce deformation through contact force in individual following periods. A sequence of contact actions at a plurality of locations on the one or more surfaces of the sensing device is performed and the location information for the touch points recorded.

For touch recognition, 189 (27*7) groups of different inflation states and touch points are acquired. Each group of data includes 30-second capacitance signals (i.e., 900 frames as the sampling speed is 30 fps) and the index of the corresponding touch point. The data is exclusively divided into training (125×30=3750 seconds, 3750×30=112500 frames), validation (32×30=960 seconds, 960×30=28800 frames) and testing (32×30=960 seconds, 960×30=28800 frames) sets. For deformation tracking, a group of data consists of capacitance signals of 30 seconds and the trajectory of visual markers recorded by cameras. The data without touch and with occlusion issues is manually filtered. 146 groups of data is obtained which is exclusively divided into training (108×30=3240 seconds, 3240×30=97200 frames), validation (18×30=540 seconds, 540×30=16200 frames) and testing (20×30=600 seconds, 600×30=18000 frames) sets.

For deformation tracking, a group of data consists of capacitance signals of 30 seconds and the trajectory of visual markers recorded by cameras. The data without touch and have occlusion issues is manually filtered. 146 groups of data is obtained which is exclusively divided into training (108×30=3240 seconds, 3240×30=97200 frames), validation (18×30=540 seconds, 540×30=16200 frames) and testing (20×30=600 seconds, 600×30=18000 frames) sets.

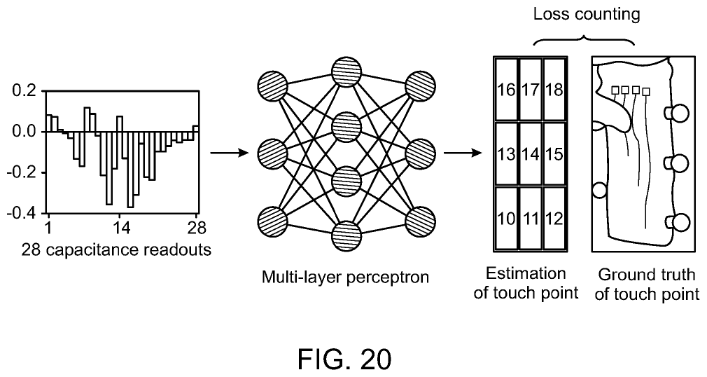

FIG. 20 is a schematic diagram of a neural network architecture employed to achieve touch point classification. The neural network architecture may also be referred to a multi-layer perceptron (MLP). In this experimental, 19 different classes are used in this study corresponding to 18 different touch points and one case without touch. The input of the MLP is 28 calibrated capacitance readouts in one frame. The MLP outputs a vector with a size of 19, indicating the class probability. A cross-entropy based loss function is used. The MLP has one hidden layer with 128 neurons. The activation function for the hidden layer is ReLU. Dropout (p=0.1) is used to prevent overfitting. The output of the neural network is the location of the touch or touch region.

The training of the MLP is implemented in Pytorch. The Adam optimizer is used to update the learnable parameters to minimize the cross-entropy loss between the predicted and ground truth touch points. The initial learning rate is set to 0.001 and decayed by a factor of 1.2 every 15 epochs. 100 epochs of training are used with a batch size of 256 using the training set and save the network with the smallest loss on the validation set. The training process takes 10 minutes on one Nvidia Quadro P5000 GPU card.

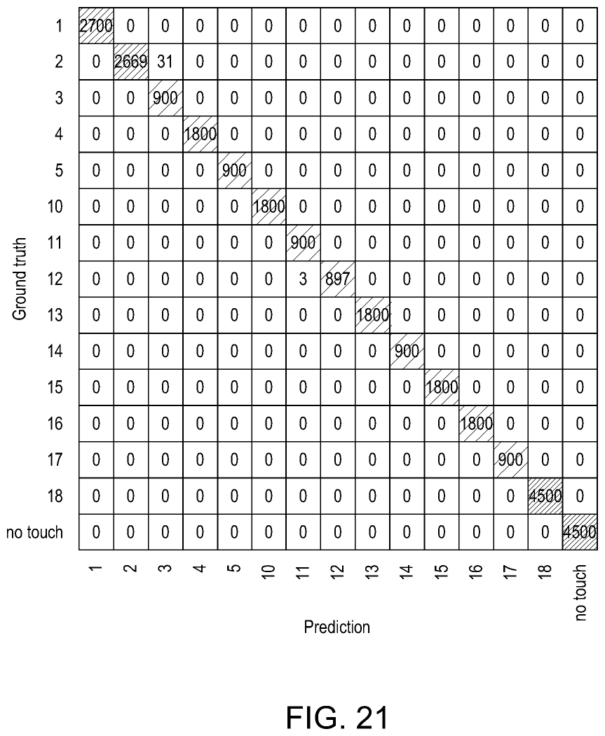

Following the training process, the MLP desmonstrated 99.88% classification accuracy on the testing set. It demonstrates that the proposed flexible skin can estimate touch points using a simple deep learning model even when the signals are seriously interfered by the inflation of the robot body. The confusion map of the classification results is shown in FIG. 21. The confusion map suggests that only 34 out of 28800 frames of testing samples are misclassified. All misclassifications occur between adjacent sub-regions. For example, 34 touches on the sub-region 2 are incorrectly classified as sub-region 3. This is because signals induced by touches on adjacent sub-regions have relatively high similarity, which may confuse the network.

While a trained model to output touch location information is described with reference to the sensor module of FIG. 15, it will be understood that the sensor module of other embodiments, for example, the sensor module of FIG. 4, may be used to train such a model.

Turning to deformation tracking, estimating coordinates of visual markers based on capacitance signals can be treated as a set-to-set issue. The capacitance-to-deformation transformer (C2DT) described above is employed. The C2DT is a transformer-based architecture developed to reconstruct point clouds of the geometry of the soft robot. The structure of the C2DT is described with reference to FIG. 8.

The cameras and readout electronics are synchronized by an auto-click script, which leads to a slight delay between data recorded by different devices. Therefore, 10 frames of calibrated capacitance signals to C2DT are inputted to alleviate this problem. The position signals consist of the location information of the electrode pair to form the capacitor, which can help the C2DT distinguish capacitance readouts generated by different electrode pairs. The squared error between estimation and ground truth is selected as the loss function.

The above description focused on deformations caused by user interaction (e.g., touch) rather than inflation (which is known in most scenarios, as the volume of air injected into the chamber is controllable). However, the signals induced by these deformations are much smaller compared with signals triggered by inflation. It may be challenging to estimate directly the coordinates of visual markers. In order to address the issue, the first frame in each trajectory is used as a priori knowledge, i.e., the capacitance readouts are used as the reference to calibrate the capacitance input and the coordinates of markers are used as the source sequence of the transformer decoder.

The training of the MLP is implemented in Pytorch. We use the Adam optimizer to update the learnable parameters to minimize the squared loss between predicted and ground truth coordinates. The initial learning rate is set to 0.001 and decayed by a factor of 1.2 every 15 epochs. We run 150 epochs of training with a batch size of 255 using the training set and save the network with the smallest loss on the validation set. The training process takes 2.5 hours on three Nvidia Quadro P5000 GPU cards.

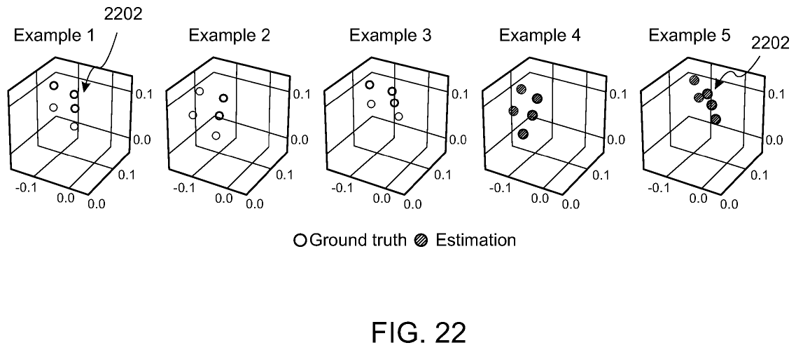

Average distance (AD) between estimated and ground truth coordinates of markers is used to evaluate the performance of the modified C2DT, which is defined as: where N is the number of samples in the testing set, M is the number of visual markers, pid is the ground truth coordinates of the ith visual marker for the ith testing sample and pid is the estimated coordinates of the ith visual marker for the ith testing sample. After training, the C2DT can achieve 2.905±2.207 mm AD error. It demonstrates that, with a priori knowledge (the capacitance signals and coordinates of markers in the first frame of each trajectory), the proposed skin can be applied to track the deformation using C2DT even in the environments with severe interference (inflation and permittivity variations caused by touch). The examples of several tracking results are shown in FIG. 22. The estimated visual markers (red) and the ground truth visual markers (blue) are observed to be close in all cases, indicating the high accuracy of deformation tracking.

The ground truth markers (for example, marker 2202) represents the location of the physical markers attached to the manipulator, which is captured by the tracking cameras. The blue ground truth represents the co-ordinates of visual markers collected by the cameras. The red estimation (for example, the marker 2204) represents the output of the network. FIG. 22 shows overlap between the output of the network and the location of the physical markers for all points.

Accordingly, the above description of the specific embodiments are made by way of example only and not for the purposes of limitations. It will be clear to the skilled person that minor modifications may be made without significant changes to the operation described.

1. A sensing device comprising:
a plurality of electrodes configured to be distributed about one or more surfaces of a deformable object,
wherein the plurality of electrodes are operable to generate capacitance signal output from a plurality of selected pairings of the plurality of electrodes, wherein the plurality of electrodes are distributed about the one or more surfaces of a deformable object such that the plurality of selected pairings comprise at least one proximate pairing and at least one non-proximate pairing,
wherein the generated capacitance signal output for a pairing of electrodes is dependent on at least one of: a distance between the electrodes; shape and/or orientation of the electrodes and at least one property of the material between the pairing.

2. The sensing device as claimed in claim 1, wherein the generated capacitance signal output is processable to determine information associated with the deformable object, wherein the information comprises at least one of: shape information; deformation information; force information; and/or velocity field information.

3. The sensing device as claimed in claim 1, wherein at least one of the plurality of electrodes is deformable, stretchable and/or compressible.

4. A sensing device as claimed in claim 1, wherein the plurality of electrodes comprise two or more proximal electrodes and two or more distal electrodes and wherein the selected pairings comprise at least one pairing between a proximal electrode and a distal electrode and at least one pairing between two proximal electrodes and/or at least one pairing between two distal electrodes.

5. A sensing device as claimed in claim 1, wherein the plurality of electrodes are distributed along the one or more surfaces thereby to form a three dimensional spatial distribution wherein the three dimensional spatial configuration is continuously deformable from a planar configuration.

6. A sensing device as claimed in claim 1, wherein the capacitance signal output is processable to obtain deformation information associated with at least one of: bending, twisting, elongation, expansion, compression of the object.

7. A sensing device as claimed in claim 1, wherein the plurality of electrodes are laterally disposed along a first surface of the deformable object and at least a second surface of the deformable object.

8. A sensing device as claimed in claim 1, wherein the plurality of selected pairings comprise at least one pairing of a first electrode with a non-neighbouring electrode of the plurality of electrodes.

9. A sensing device as claimed in claim 1, wherein the plurality of electrodes are operable to generate capacitance signal output from the plurality of selected pairings in accordance with a pre-determined sequence.

10. A sensing device as claimed in claim 1, wherein the plurality of selected pairings comprise a subset, for example, a degenerate subset, of all pairings of the plurality of electrodes.

11. A sensing device as claimed in claim 1, wherein the plurality of electrodes comprise at least two electrodes arranged in a first plane and at least two electrodes arranged is in a second plane, wherein the first plane is substantially non-parallel to the second plane.

12. A sensing device as claimed in claim 1, wherein the plurality of electrodes are disposed in one or more deformable substrates, the one or more deformable substrates being conformable to a surface by deformation, optionally;
wherein the one or more deformable substrates are stretchable in at least a lateral direction, further optionally, wherein the one or more deformable substrates are stretchable to increase or decrease a distance between two or more of the plurality of electrodes.

13. (canceled)

14. A sensing device as claimed in claim 1, wherein at least one of a), b), c), d), e):
a) the plurality of electrodes form one or more sensor modules, wherein each sensor module is continuously deformable from a planar configuration and/or conformable to a surface;
b) wherein the plurality of electrodes comprise a stretchable conductive material;
c) wherein the plurality of electrodes comprise an elongated conductive portion, wherein the elongated conductive portion is configured to be further elongated in response to a force, optionally, wherein the elongated conductive portions of the plurality of electrodes are provided in a parallel arrangement;
d) wherein the plurality of electrodes are provided on or integrated into one or more deformable substrates for applying to the deformable object and/or wherein the one or more electrodes are integrated into the surface of the deformable object;
e) the plurality of electrodes are distributed in accordance with a pre-determined layout.

15. (canceled)

16. (canceled)

17. (canceled)

18. A sensing device as claimed in claim 1, wherein the deformable object comprises at least one of: a robot arm; other robotic manipulator; a part of a human body and/or a wearable object.

19. A sensing device as claimed in claim 1, wherein the plurality of electrodes are distributed in accordance with a pre-determined layout.

20. A sensing device as claimed in claim 1, further comprising a processing resource configured to process capacitance signal output or capacitance data obtained from the capacitance signal output to obtain said information associated with the deformable object, optionally, wherein the processing circuitry is configured to apply at least one pre-determined model to obtain the information.

21. A method comprising:
obtaining capacitance signal output data representative of capacitance signal output from a plurality of selected pairings of a plurality of electrodes distributed about one or more surfaces of a deformable object, wherein the generated capacitance signal output for a pairing of electrodes is dependent on at least one of: a distance between the pairing; shape and/or orientation of the electrodes and at least one material property of the material between the pairing;
wherein the capacitance signal output data is processable to determine information associated with the deformable object.

22. The method of claim 21, wherein at least one of a), b), c:
a) the method further comprises processing the capacitance signal output to determine said information, wherein processing comprises applying at least one model to the capacitance signal output, for example, a model determined using a machine learning derived process;
b) the processing of the capacitance signal output is performed as part of at least one of: a shape reconstruction process, a deformation detection process;
c) wherein the at least one model is configured to output touch information and deformation information.

23. (canceled)

24. (canceled)

25. A method for training at least one model comprising:
obtaining training data comprising:
capacitance signal output data representative of capacitance signal output from a plurality of selected pairings of a plurality of electrodes arranged laterally along one or more surfaces of a deformable object; and
further data representative of information associated with the deformable object; and
performing a model training process using the obtained training data to obtain at least one trained model for obtaining further information for the deformable object using further obtained capacitance signal output.

26. The method of claim 25, wherein at least one of a), b):
a) the obtained capacitance signal output data is obtained for one or more spatial configurations of the plurality of electrodes and/or in response to one or more deformations applied to the deformable object; and wherein the obtained information comprises obtaining shape and/or deformation information data corresponding to the one or more spatial configuration and/or the one or more applied deformations.
b) the obtained capacitance signal output data is obtained in response to performing a sequence of contact actions at a plurality of locations on the one or more surfaces and wherein the obtained information comprises contact location information.

27. (canceled)

28. (canceled)
